(19) United States
(12) Patent Application Publication
(10) Pub. No.: US 2010/0007232 A1
(43) Pub. Date: Jan. 14, 2010

(54) Sintered Magnet Motor

(75) Inventors: Matahiro Komuro, Hitachi (JP); Yuichi Satsu, Hitachi (JP); Yutaka Matsunobu, Mito (JP); Takashi Yasuhara, Yotsukaido (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi Ltd., Chiyoda-ku (JP)

(21) Appl. No.: 12/472,130

(22) Filed: May 26, 2009

(30) Foreign Application Priority Data
Jul. 11, 2008 (JP) 2008-181249

(51) Int. Cl. H02K 21/12

(52) U.S. Cl. 310/156.01

(57) ABSTRACT

Disclosed herein is a sintered magnet motor having a sintered magnet rotor, the rotor comprising: a ferromagnetic material comprising iron as a main ingredient to be sintered; a fluorine compound or an oxyfluoride compound formed in the inside of a crystal grain or to a portion of a grain boundary of the ferromagnetic material; and at least one of alkalis, alkaline earth elements, and rare earth elements contained in the fluorine compound or the oxyfluoride compound; a portion of the fluorine compound or the oxyfluoride compound being distributed with a concentration gradient established from the surface to the inside of the ferromagnetic material, and a rare earth element being distributed with a concentration gradient established between the grain boundary surface and the parent phase of the ferromagnetic material, wherein the concentration distribution of the fluorine compound is asymmetrical when viewed from the pole center of the sintered magnet rotor. The amount of use of a fluorine compound can be decreased in this sintered magnet motor.

### BACKGROUND OF THE INVENTION

1. Field of the Invention

The present invention relates to a rare earth magnet and a manufacturing method thereof and, more in particular, it relates to a sintered magnet motor using a magnet having a high energy product or a high heat resistance in which the amount of use of a heavy rare earth element is decreased.

The present invention relates to a sintered magnet in which a fluorine-containing phase is formed at a grain boundary or to a portion in a grain to an Fe type magnet material for improving the heat resistance of magnets of Fe-type including an R—Fe (R: rare earth element) type magnets, and magnetic properties and reliability are improved by the fluorine-containing phase, and a rotary machine using the sintered magnet. A magnet having the fluorine-containing phase is utilized for a magnet having properties conforming to various magnetic circuits, and a magnet motor of applying the magnet, etc. Such a magnet motor includes those used for driving hybrid cars, starters, and electromotive power steerings.

2. Description of the Related Art

Existent sintered rare earth magnets containing fluorine compounds or oxyfluoride compounds are described in JP-A-2003-282312, 2006-303436, 2006-303435, 2006-303434, and 2006-303433. In the related art, the fluorine compound used for the treatment is a powdery material or a mixture for a powder and a solvent and it is difficult to efficiently form a fluorine-containing phase along the surface of a magnet powder.

Further, in the existent methods, since the fluorine compound used for the treatment comes into point contact with of the surface of the magnet powder and the fluorine-containing phase does not come into surface contact easily with the magnetic powder as in the method of the invention, the existent methods require more amount of starting material for the treatment and a heat treatment at higher temperature. In US Laid-Open Patent: US2005/0081959A1, a fine powder (1 to 20 μm) of a rare earth fluoride compound is mixed with an NdFeB powder but it does not disclose an example in which the powder grows in a plate shape at intervals within the grain of the magnet. Further, IEEE TRANSACTIONS ON MAGNETICS, VOL. 41 No. 10(2005), pages from 3844 to 3846 describes that a fine powder (1 to 5 μm) of DyF₃ or TbF₃ is coated on the surface of a sintered micro-magnet, this is not a treatment by a solution of a fluorine compound. While it is described that Dy or F is absorbed to the sintered magnet to form NdOF or Nd oxide, it contains no descriptions regarding a magnet in which the symmetricity of the concentration gradient of carbon, heavy rare earth elements, light rare earth elements in an oxyfluoride compound is different in the circumferential direction from the center of one pole disposed to a rotor.

In the existent inventions described above, pulverized powder such as of a fluorine compound is used as a starting material for forming a fluorine-containing phase as a layered configuration to an NdFeB magnetic powder but they have no descriptions regarding the state of a permeable solution at a low viscosity. Accordingly, it is difficult to improve the magnetic properties and lower the concentration of the rare earth element in a magnetic powder in which the heat treatment temperature necessary for diffusion is high, and the magnetic properties are deteriorated at a temperature lower than that of the sintered magnet.

Accordingly, the heat treatment temperature is high and a great amount of the fluorine compound is necessary for diffusion in the existent method, and it was difficult to apply the treatment to a magnet having a thickness exceeding 10 mm.

### SUMMARY OF THE INVENTION

In view of the foregoing problems, the present invention intends to provide a sintered magnet motor capable of reducing the amount of use of the fluorine compound.

To attain the object described above, the present invention provides a sintered magnet motor having a sintered magnet rotor, the rotor comprising:

a ferromagnetic material comprising iron as a main ingredient to be sintered;

a fluorine compound or an oxyfluoride compound formed in the inside of a crystal grain or to a portion of a grain boundary of the ferromagnetic material; and

at least one of alkalis, alkaline earth elements, and rare earth elements contained in the fluorine compound or the oxyfluoride compound;

a portion of the fluorine compound or the oxyfluoride compound being distributed with a concentration gradient established from the surface to the inside of the ferromagnetic material, and a rare earth element being distributed with a concentration gradient established between the grain boundary surface and the parent phase of the ferromagnetic material,

wherein the concentration distribution of the fluorine compound is asymmetrical when viewed from the pole center of the sintered magnet rotor.

According to the invention, the amount of use of the fluorine compounds necessary for the improvement of the performance including increase of the coercive force of the sintered magnet motor can be decreased by making the concentration distribution of the fluorine compound asymmetrical in view of the center of the pole of the sintered magnet rotor.

### BRIEF DESCRIPTION OF THE DRAWINGS

Other objects and advantages of the invention will become apparent from the following description of embodiments with reference to the accompanying drawings in which:

FIG. 1 is a schematic view of a cross section perpendicular to the axial direction of a sintered magnet motor according to an embodiment of the present invention;

FIG. 2 is a schematic view of a cross section perpendicular to the axial direction of a sintered magnet motor according to an embodiment of the present invention, in which the arrangement of sintered magnets is different from that in FIG. 1;

FIG. 3 is a schematic view of a cross section perpendicular to the axial direction of a sintered magnet motor according to an embodiment of the present invention, in which the sintered magnets are different from that in FIG. 2;

FIG. 4 shows an arrangement of sintered magnets for one pole at the cross section of a rotor according to an embodiment of the present invention;

FIG. 5 shows an arrangement of sintered magnets for one pole at the cross section of a rotor according to an embodiment of the present invention, in which sintered magnets are different from those in FIG. 4;

FIG. 6 shows an arrangement of sintered magnets for one pole at the cross section of a rotor according to an embodiment of the present invention, in which sintered magnets are different from those in FIG. 5;

FIG. 7 shows an arrangement of sintered magnets for one pole at the cross section of a rotor according to an embodiment of the present invention, in which sintered magnets are different from those in FIG. 6;

FIGS. 8A to 8F show sintered magnets subjected to various fluoride treatments according to an embodiment of the invention in which

FIG. 8A shows an example of a sintered magnet applied with a fluoride treatment,

FIG. 8B shows another example of a sintered magnet applied with a fluoride treatment,

FIG. 8C shows a further example of a sintered magnet applied with a fluoride treatment,

FIG. 8D shows a further example of a sintered magnet applied with a fluoride treatment,

FIG. 8E shows a further example of a sintered magnet applied with a fluoride treatment, and

FIG. 8F shows a further example of a sintered magnet applied with a fluoride treatment, and

FIG. 9 is a perspective view for a rotor of a surface magnet motor using sintered magnets according to an embodiment of the present invention.

### DETAILED DESCRIPTION OF THE PREFERRED EMBODIMENTS

In addition to a sintered magnet motor having the feature of the present invention described above, other sintered magnet motors having other main features of the present invention are to be described below.

(1) A sintered magnet motor having a sintered magnet rotor, the rotor comprising:

a sintered magnet material comprising iron as a main ingredient;

a fluorine compound or an oxyfluoride compound formed in the inside of a crystal grain or to a portion of the grain boundary of the material for the sintered magnet; and

at least one of alkalis, alkaline earth elements, and rare earth elements contained in the fluorine compound or the oxyfluoride compound;

a portion of the fluorine compound or the oxyfluoride compound extending so as to pass through the surface of the ferromagnetic material to the inside and to be continuous for the other surface of the ferromagnetic material, and

the rare earth element being distributed with a concentration gradient established between the grain boundary surface and the parent phase of the ferromagnetic material,

wherein the concentration distribution of the fluorine compound is asymmetrical when viewed from the pole center of the sintered magnet rotor.

(2) A sintered magnet motor having a sintered magnet rotor, the rotor comprising:

a sintered magnet material comprising iron as a main ingredient;

a fluorine compound or an oxyfluoride compound formed in the inside of a crystal grain or to a portion of the grain boundary of the material for the sintered magnet; and

at least one of alkalis, alkaline earth elements, and rare earth elements contained in the fluorine compound or the oxyfluoride compound;

a portion of the fluorine compound or the oxyfluoride compound extending so as to pass through the surface of the ferromagnetic material to the inside and to be continuous for the other surface of the ferromagnetic material, and

fluorine being distributed with a concentration gradient established between the grain boundary surface and the parent phase of the ferromagnetic material,

wherein the concentration distribution of the fluorine is asymmetrical when viewed from the pole center of the sintered magnet rotor.

(3) A sintered magnet motor having a sintered magnet rotor, the rotor comprising:

a sintered magnet material comprising iron as a main ingredient;

a fluorine compound or an oxyfluoride compound formed in the inside of a crystal grain or to a portion of the grain boundary of the material for the sintered magnet; and

at least one of alkalis, alkaline earth elements, and rare earth elements contained in the fluorine compound or the oxyfluoride compound;

a portion of the fluorine compound or the oxyfluoride compound extending so as to extend from the surface of the ferromagnetic material along the crystal grain boundary and to be continuous for the other surface of the ferromagnetic material, and,

fluorine being distributed with a concentration gradient established between the grain boundary surface and the parent phase of the ferromagnetic material,

wherein the concentration distribution on the average of the fluorine is asymmetrical when viewed from the pole center of the sintered magnet rotor.

(4) A sintered magnet motor having a sintered magnet rotor, the rotor comprising:

a sintered magnet material comprising iron as a main ingredient;

a fluorine compound or an oxyfluoride compound formed in the inside of a crystal grain or to a portion of the grain boundary of the material for the sintered magnet; and

at least one of alkalis, alkaline earth elements, and rare earth elements contained in the fluorine compound or the oxyfluoride compound;

a portion of the fluorine compound or the oxyfluoride compound extending so as to pass through the surface of the ferromagnetic material to the inside and to be continuous for the other surface of the ferromagnetic material, and

fluorine being distributed with a concentration gradient established between the grain boundary surface and the parent phase of the ferromagnetic material,

wherein symmetricity for the distribution of the residual magnetic flux density of a sintered magnet is different from that for the distribution of the coercive force thereof, the sintered magnet being disposed along the outer periphery of the sintered magnet rotor.

(5) A sintered magnet motor comprising:

a ferromagnetic material comprising iron and a rare earth element as a main ingredient;

a fluorine compound or an oxyfluoride compound formed in the inside of a crystal grain or to a portion of the grain boundary of the ferromagnetic material;

at least one of alkalis, alkaline earth elements, metal elements, and rare earth elements, and carbon, which are contained in the fluorine compound or the oxyfluoride compound; and

a continuous layer which extends such that the fluorine compound or the oxyfluoride compound may not be connected to the outermost surface at the grain boundary at any portion of the ferromagnetic material;

wherein at least one of the alkalis, alkaline earth elements, metal elements, or rare earth elements segregates along the grain boundary of the parent phase of the ferromagnetic material along the continuous layer; at least one of the alkalis, alkaline earth elements, metal elements, and rare earth elements segregates so as to increase the concentration from the center to the outside of the grain in the grain having a cubic structure of the fluorine compound or the oxyfluoride compound; and the concentration distribution of the rare earth element obtained by the analysis of the composition for the volume of 100 μm³ or more is laterally asymmetrical about the pole of the sintered magnet rotor.

(6) A sintered magnet motor having a rotor including a sintered magnet, the sintered magnet comprising:

a ferromagnetic material comprising iron as a main ingredient to be sintered; and

a fluorinated portion formed in the ferromagnetic material, the fluorinated portion obtained by subjecting a fluoride compound or an oxyfluoride compound to a fluorination treatment;

wherein the fluorinated portion is narrowed in the central portion in the axial direction of the rotor and widened on both ends apart from the central portion in the axial direction.

(7) A sintered magnet motor having a rotor including a sintered magnet, the sintered magnet comprising:

a ferromagnetic material comprising iron as a main ingredient to be sintered; and

a fluorinated portion formed in the ferromagnetic material, the fluorinated portion obtained by subjecting a fluoride compound or an oxyfluoride compound to a fluorination treatment;

wherein a not-fluorinated portion except for the fluorinated portion is present at the central portion of two planes perpendicular to an anisotropic direction.

(8) A sintered magnet motor, which is manufactured by using a treating solution in which rare earth fluoride or an alkaline earth metal fluoride in a sol state is swollen into a solvent comprising an alcohol as a main ingredient, by a step of impregnating a solution of a fluorine compound in a void between magnetic powders of a temporary molding material after orientation in a magnetic field, or a step of temporary molding in a magnetic field after mixing with a magnetic powder coated with a fluorine compound by a surface treatment, or a method of thermal diffusion by using electromagnetic waves after solution treating a sintered magnet block with a fluoride.

The sintered magnet motor has advantages, for example, that the fluorine compound can be formed more easily to the inside of the sintered magnet than in the case of using pulverized fluorine compound powder, the amount of use of the fluorine compound can be decreased, and the uniformity of coating can be improved, and has a feature in which portions where fluorine or rare earth element is segregated are formed to a local portion of the magnet surface, and the segregated portions are asymmetrical in view of the center of one pole of the rotor.

Prior to explanation for the embodiments of the present invention, the outline of the methods for attaining the purpose of the invention is to be described below.

In any of the methods, a fluorine compound solution having light transmittance and not containing a pulverized powder is used. Such a solution is impregnated into and sintered in a low density molding material having voids, or a surface treated magnetic powder in which a fluorine compound is previously coated on the surface of the magnetic powder and a not-coated magnetic powder are mixed and then temporarily molded and sintered. Alternatively, the fluorine compound is locally diffused from the surface of a sintered block.

When a sintered magnet comprising Nd₂Fe₁₄B as a main phase is manufactured, a magnetic powder is temporarily molded in a magnetic field after controlling the grain size distribution of the magnetic powder. Since voids are present between the magnetic powders in the temporary molding material, the solution of the fluorine compound can be coated as far as the central portion of the temporary molding material by impregnating the solution of the fluorine compound in the voids.

In this case, the solution of the fluorine compound is preferably a solution having high transparency, light transmittance, or low viscosity. By using such a solution, a solution of the fluorine compound can be impregnated into fine voids between the magnetic powers. Impregnation can be carried out by bringing a portion of the temporary molding material into contact with the solution of the fluorine compound, the solution of the fluorine compound is coated along the surface where the temporary molding material and the solution of the fluorine compound are in contact with each other and, when a void of 1 nm to 1 mm is present at the coated surface, the solution of the fluorine compound is impregnated along the magnetic powder surface of the void.

The direction of impregnation is the direction where the continuous void is present in the temporary molding material and this depends on the conditions for the temporary molding and the shape of the magnetic powder. Since the amount of coating is different between the contact surface of the solution of the fluorine compound to be impregnated and the vicinity of the non-contact surface, a concentration difference is sometimes observed to a portion of elements that constitute the fluorine compound after sintering.

Further, difference is sometimes present in the concentration distribution of the fluorine compound on the average between the contact surface of the solution and the surface in the perpendicular direction. The solution of the fluorine compound is a solution comprising a carbon-containing fluorine compound, or oxyfluoride compound partially containing oxygen (hereinafter referred to as oxyfluoride) having a structure similar to an amorphous structure containing one or more alkali metal elements, alkaline earth elements, or rare earth elements, and the impregnation treatment can be effected at a room temperature.

When the solvent is removed from the impregnated solution by a heat treatment at 200° C. to 400° C., and a heat treatment is applied at 500° C. to 800° C., carbon, rare earth element and fluorine compound constituting element are diffused between the fluorine compound and the magnetic powder or at the grain boundary.

The magnetic powder contains from 10 to 5000 ppm of oxygen and contains light elements such as H, C, P, Si, Al, or a transition metal element as the impurity element. Oxygen contained in the magnetic powder is present not only as a rare earth oxide or an oxide of a light element such as Si or Al but also as an oxygen-containing phase deviated in view of the composition from a stoichiometrical composition in the parent phase or at the grain boundary.

The oxygen-containing phase decreases magnetization of the magnetic powder and also gives an effect on the profile of the magnetization curve. That is, it lowers the value of the residual magnetic flux density, decreases the anisotropic magnetic field, deteriorates the squareness of the demagnetization curve, decreases the coercive force, increases the irreversible demagnetizing factor, increases the thermal demagnetization, fluctuates the magnetization properties, deteriorates the corrosion resistance, lowers the mechanical properties, etc. thereby lowering the reliability of the magnet.

Since oxygen gives undesired effects on various properties as described above, a step of not leaving oxygen in the magnetic powder has been considered. The rare earth fluoride compounds impregnated and grown on the surface of the magnetic powder partially contains a solvent, and REF₃ is grown by a heat treatment at 400° C. or lower (RE: rare earth element), and heated and kept at a temperature from 400 to 800° C. under a vacuum degree of 1×10⁻³ Torr or less. The retention time is 30 min.

By the heat treatment, iron atoms, rare earth elements, and oxygen of the magnetic powder are diffused into the fluorine compound and then constituent elements of the magnetic powder are observed in REF₃, REF₂ or RE(OF) or in the vicinity of the grain boundary thereof. Since impregnation proceeds along the void passing through from the surface of the molding material, a fluorine-containing grain boundary phase is formed as a substantially continuous layer extending from the surface to another surface in the magnet after sintering.

By using the treating solution described above, the fluorine compound can be diffused to and sintered in the inside of the magnetic body at a relatively low temperature of 200 to 100° C. The impregnation can provide the following advantages.

(1) The amount of use of the fluorine compound necessary for the treatment can be decreased.

(2) The treatment can be applied to a sintered magnet of a thickness of 10 mm or more

(3) The diffusion temperature of the fluorine compound can be lowered.

(4) Heat treatment for diffusion after sintering is not required.

With the features described above, remarkable effects can be obtained for the thick plate magnet including, for example, increase of a residual magnetic flux density for the impregnated portion, increase of a coercive force, improvement for the squareness of a demagnetization curve, improvement for the thermal demagnetization properties, improvement for the magnetization property, improvement for the anisotropy, improvement for the corrosion resistance, lowering of loss, improvement for the mechanical strength, decrease in the manufacturing cost, etc.

In the case where the magnetic powder is an NdFeB type, Nd, Fe, B, or additive elements and impurity elements are diffused in the fluorine compound at a heating temperature of 200° C. or higher. At this temperature, the fluorine concentration in the fluorine compound layer is different depending on the place, and REF₂, REF₃ (RE: rare earth element) or an oxyfluoride compound thereof is formed as a layered or plate shape discontinuously, and a substantially continuous fluorine compound is formed in a layered shape in the impregnating direction to form a layer which is continuous from the surface to the opposite surface.

The driving power for diffusion is, for example, temperature, stress (strain), concentration difference, defects, etc. and the result of the diffusion can be confirmed by an electron microscope or the like. When a solution not using a pulverized powder of the fluorine compound is used by impregnation, since the fluorine compound can be formed to the central portion of the temporary molding material already at a room temperature and can be diffused at a low temperature, the amount of use of the fluorine compound can be decreased, and this is particularly effective in a case of an NdFeB magnet powder in which the magnetic properties thereof are deteriorated at high temperature.

The NdFeB type magnetic powder contains a magnetic powder containing a phase equivalent to the crystal structure of Nd₂Fe₁₄B in the main phase and transition metal such as Al, Co, Cu, and Ti may also be contained in the main phase described above. Further, B may be partially substituted by C. Further, a compound such as Fe₃B or Nd₂Fe₂₃B₃ or an oxide may also be contained to the phase other than the main phase. Since the fluorine compound layer shows a resistance higher than the NdFeB type magnetic powder at a temperature of 800° C. or lower, the resistance of the NdFeB sintered magnet can be increased by forming the fluorine compound layer and, as a result, the loss can be decreased. The fluorine compound layer may contain any element as an impurity in addition to the fluorine compound with no problem so long as this is an element not showing ferromagnetic property in the vicinity of a room temperature where less effect is given on the magnetic properties. Fine particles such as of a nitrogen compound or carbide may also be mixed in the fluorine compound with an aim of providing high resistance or improving magnetic properties.

The sintered magnet formed with the fluorine compound by the impregnation step contains a layer where fluorine is continuous from the surface to another surface of the magnet, or contains a layered grain boundary containing fluorine at the inside of the magnet not connected to the surface.

Segregation of the fluorine compound is observed in the vicinity of the grain boundary for the impregnated portion, which increases the coercive force. Increase of the coercive force is from 1.1 times to 3 times as high as the not impregnated portion when a DyF type solution is used. In a portion where the coercive force is increased, since decrease of the residual magnetic flux density is as low as 5% or less, the value for the magnetic flux density at the surface of the magnet does not substantially change compared with a not-impregnated sintered magnet and only the heat resistance of the impregnated portion is improved. Then, a high coercive force is necessary only in the vicinity of a corner where a reverse magnetic field in the motor is applied and the portions requiring the high coercive force are bilaterally asymmetrical in view of the center of the pole in the radial direction. The amount of use of the heavy rare earth element can be decreased by using a method of impregnation and diffusion treatment for forming the high coercive force portions which are bilaterally asymmetric.

The present invention is to be described by way of the following preferred embodiments.

### Embodiment 1

A treating solution for forming a (Dy_{0.9}Cu_{0.1})Fₓ (x=1 to 3) rare earth fluoride coating film is prepared as described below.

(1) 4 g of Dy nitrate is introduced into 100 mL of water and dissolved completely by using a shaker or a supersonic stirrer.

(2) Hydrofluoric acid diluted to 10% is added gradually by an equivalent amount for the chemical reaction of forming DyFₓ (x=1 to 3).

(3) A solution in which DyFₓ (x=1 to 3) is formed as gelled precipitates is stirred for one hour or more by using a supersonic stirrer.

(4) After centrifugal separation by the number of rotation of 6,000 to 10,000 r.p.m., supernatants are removed and a substantially equal amount of methanol is added.

(5) After stirring a methanol solution containing a gelled DyF cluster to form complete liquid suspension, it is stirred for one hour or more by using a supersonic stirrer.

(6) The procedures (4), (5) are repeated for three to ten times till anions such as acetate ions or nitrate ions are no more detected.

(7) In the case of the DyF type solution, a substantially transparent sol-like DyFₓ is formed. As the treating solution, a methanol solution containing 1 g/5 mL of DyFₓ is used.

(8) An organic metal compound of Cu is added to the solution under the condition of not changing the solution structure.

The diffraction pattern of a solution or a film formed by drying the solution has a plurality of peaks with a half width of 1° or greater (2° to 10°). This indicates that an inter-atom distance between the additive element and fluorine or between metal elements is different from that of REₙFₘ, and the crystal structure is also different from that of REₙFₘ and REₙ(F,O)ₘ. In this case, RE represents a rare earth element, F represents fluorine, O represents oxygen, and n or m is a positive integer. Since the half width is 1° or greater, the inter-atom distance does not show a constant value as in usual metal crystals but has a certain distribution.

Such a distribution is formed because other atoms are arranged at the periphery of the atom of the metal element or the fluorine element described above in a manner different from that of the compound described above, and such atoms mainly comprise hydrogen, carbon, and oxygen. When an external energy is supplied, for example, by heating, atoms such as hydrogen, carbon and oxygen move easily to change the structure and also change the fluidity. The X-ray diffraction pattern of the sol or the gel has peaks having a half width of 1° or greater-and the structural change is observed by heat treatment, and a portion of the diffraction pattern of REₙFₘ or REₙ(F,O)ₘ appears. Even when Cu is added, it has no long periodical structure in the solution. The diffraction peak of REₙFₘ has a narrower half width than the diffraction peak of the sol or the gel.

To increase the fluidity of the solution and making the coating thickness uniform, it is important that at least one peak having a half width of 1° or greater is present in the diffraction pattern of the solution. The peak with the half width of 1° or greater, and the peak of the diffraction pattern of REₙFₘ or the oxyfluoride compound may be contained. In the case where only the diffraction pattern of REₙFₘ or oxyfluoride compound, or the diffraction pattern of 1° or less are observed mainly in the diffraction pattern of the solution, since a solid phase which is not the sol or gel is mixed in the solution, fluidity is worsened. Then, the solution described above is used and then coated to Nd₂Fe₁₄B (referred to simply as NdFeB).

(1) A sintered material of NdFeB (10×10×10 mm³) is compression molded at a room temperature, and immersed in a treating solution for forming a DyF type coating film and methanol as a solvent is removed from the block at a reduced pressure of 2 to 5 Torr.

(2) The procedure (1) described above is repeated for once to five times and heat treatment is applied within a temperature range from 400° C. to 1100° C. for 0.5 to 5 hours.

(3) A pulse magnetic field at 30 kOe or more is applied in the anisotropic direction of the anisotropic magnet formed with the surface coating film in the procedure (2) described above.

The magnetized molding material is sandwiched between magnetic poles of a DC M-H loop measuring equipment such that the magnetizing direction of the molding material is aligned with the direction of applying the magnetic field, and a magnetic field is applied between the magnetic poles to measure a demagnetization curve. An FeCo alloy is used for the pole piece of the magnetic pole that applies the magnetic field to the magnetized molding material, and the value of the magnetization is calibrated by using a pure Ni sample and a pure Fe sample of an identical shape.

As a result, the coercive force of the block of the sintered NdFeB material formed with the Dy fluoride coating film is increased from 1.1 times to twice. A short range structure is observed in the vicinity of Cu added to the solution by the removal of the solvent and this is diffused together with the solution constituent element along the grain boundary of the sintered magnet by a further heat treatment.

Cu tends to segregate together with a portion of the solution constituent element in the vicinity of the grain boundary. The composition of the sintered magnet having a high coercive force shows a trend that the concentration of the element constituting the fluoride solution is higher at the outer periphery of the magnet and lower at the central portion of the magnet. This is because when the fluoride solution containing the additive element is coated and dried to the outside of the sintered magnet block, diffusion proceeds along the vicinity of the grain boundary, along with the growth of the fluoride or the oxyfluoride containing the additive element and having the short range structure.

That is, in the sintered magnet block, concentration gradient of fluorine and Cu is observed from the outer periphery (including also fluoride at the outermost periphery) to the inside. When an element having an atom number of 18 to 86 other than Cu is added to one of fluoride, oxide or oxyfluoride containing at least one rare earth element in a slurry state, improvement for the magnetic properties such as obtainability of higher coercive force than in the case of not adding them could be confirmed.

The role of the additive elements is one of the followings:
(1) segregating in the vicinity of the grain boundary to lower the boundary energy,
(2) enhance lattice matching of the grain boundary,
(3) decreasing defects at the grain boundary,
(4) promote grain boundary diffusion of rare earth element, etc.,
(5) increasing magnetic anisotropy energy in the vicinity of the grain boundary,
(6) making the boundary to the fluoride, oxyfluoride or fluoride carbonate of the cubic structure smooth,
(7) enhancing anisotropy of the rare earth element,
(8) removing oxygen from the parent phase,
(9) increasing curie temperature of the parent phase,
(10) segregating additive element containing Cu around the grain boundary as the center to make the grain boundary phase non-magnet,
(11) segregating additive elements to a further outside of the fluoride or oxyfluoride that grows at the outermost periphery of the sintered magnet thereby contributing to the improvement of the corrosion resistance and the control for the grain boundary composition, and
(12) weakly bonding at the boundary with the magnetic moment of the parent phase.

As the result thereof, it is recognized one of the effects of increasing the coercive force, improving the squareness of a demagnetization curve, increasing the residual magnetic flux density, increasing the energy product, increasing the curie temperature, decreasing the magnetizing magnetic field, decreasing the temperature dependence of the coercive force or the residual magnetic flux density, improving the corrosion resistance, increasing the specific resistivity, or decreasing the thermal demagnetization ratio.

A transition metal element may be usable as the additive element instead of Cu, and the concentration distribution thereof shows a trend that the concentration decreases from the outer periphery to the inside of the sintered magnet and increases at the grain boundary on the average. The width of the grain boundary tends to be different between the vicinity of the grain boundary triple junction and a place apart from the grain boundary triple junction, and it shows a trend that the width is larger and the concentration is higher in the vicinity of the grain boundary triple junction. The transition metal additive element tends to be segregated at the grain boundary phase, the end of the grain boundary, or at the outer periphery in the grain from the grain boundary to the inside of the grain (on the side of the grain boundary).

Since the additive elements are thermally diffused after the treatment by using the solution, they have a compositional distribution different from that of the elements added previously to the sintered magnet, and reach a high concentration in the vicinity of the grain boundary where fluorine or rare earth element is segregated, segregation of the previously added element is observed at the grain boundary where fluorine is less segregated, and average concentration gradient appears from the outside to the inside (on the side of the magnet) of the fluoride at the outermost surface of the magnet block. In the case where the concentration of the additive element in the solution is low, this can be confirmed as the concentration gradient or the concentration difference.

As described above, when the additive element is added to the solution, and the properties of the sintered magnet are improved by the heat treatment after coating the solution to the magnet block, the sintered magnet has features as described below.

(1) The concentration gradient or the average concentration difference of the transition metal element is observed in the vicinity of the fluoride layer at the outermost surface.

(2) Segregation of the transition metal element together with fluorine is present in the vicinity of the grain boundary.

(3) The fluorine concentration is high at the grain boundary phase, the fluorine concentration is low at the outside of the grain boundary phase, segregation of the transition metal element is observed in the vicinity of a place where the difference of the fluorine concentration is present, and average concentration gradient or the concentration difference is observed from the surface to the inside of the magnet block.

(4) A fluoride layer or an oxyfluoride layer having a cubic structure or a structure other than the cubic structure containing the transition metal element, fluorine, and carbon grows at the outermost surface of the sintered magnet.

When a rotor is manufactured by bonding an NdFeB type sintered magnet comprising an Nd₂Fe₁₄B structure as a main phase prepared as described above with a laminated electromagnetic steel sheet, laminated amorphous or dust core, the magnet is previously inserted to a position for inserting the magnet.

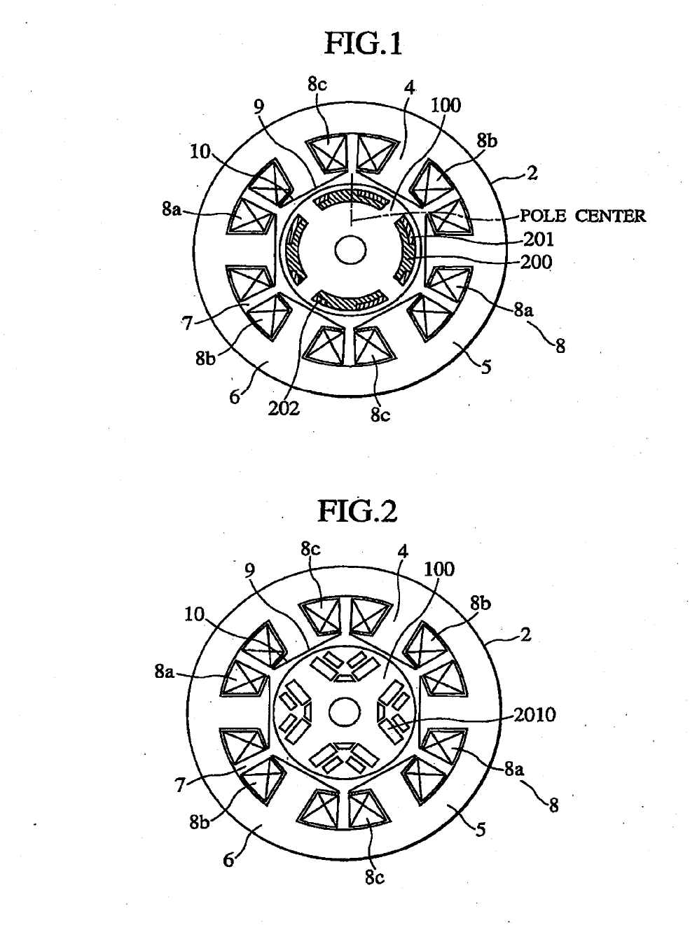

FIG. 1 is a schematic cross-sectional view perpendicular to the axial direction of a motor. A motor includes a rotor 100 and a stator 2, the stator includes a core back 5 and teeth 4, and each of coils 8a, 8b, and 8c of a coil group (U phase windings 8a, V phase windings 8b, W phase windings 8c in three phase windings) is inserted into the coil insertion position 7 between the teeth 4. A rotor insertion portion 10 for housing the rotor is defined from the top end 9 of the teeth 4 to the center of the shaft, and the rotor 100 is inserted to the position.

Sintered magnets are inserted to the outer periphery of the rotor 100 and each magnet has a portion 200 not treated with a fluoride solution and portions 201, 202 treated with the fluoride. The area is different between the fluoride treated portions 201 and 202 of the sintered magnet, and a portion undergoing a larger magnetic field strength of a reverse magnetic field by the magnetic field design is subjected to a fluoride treatment for a larger area to increase the coercive force. As described above, by applying the fluoride treatment partially to the outer periphery of the sintered magnet, the amount of use of Dy can be decreased and the demagnetization resistance can be improved, which leads to extension for the range of the working temperature and increase of the motor power.

### Embodiment 2

A treating solution for forming a (Dy_{0.9}Cu_{0.1})Fₓ (x=1 to 3) rare earth fluoride coating film is prepared as described below.

(1) 4 g of Dy nitrate is introduced into 100 mL of water and dissolved completely by using a shaker or a supersonic stirrer.

(2) Hydrofluoric acid diluted to 10% is added gradually by an equivalent amount for the chemical reaction of forming DyFₓ (x=1 to 3).

(3) A solution in which DyFₓ (x=1 to 3) is formed as gelled precipitates is stirred for one hour or more by using a supersonic stirrer.

(4) After centrifugal separation at the number of rotation of 6,000 to 10,000 r.p.m., supernatants are removed and a substantially equal amount of methanol is added.

(5) After stirring a methanol solution containing a gelled DyF cluster to form a complete liquid suspension, it is stirred for one hour or more by using a supersonic stirrer.

(6) The procedures (4), (5) are repeated for three to ten times till anions such as acetate ions or nitrate ions are no more detected.

(7) In the case of the DyF type solution, a substantially transparent sol-like DyFₓ is formed. As the treating solution, a methanol solution containing 1 g/5 mL of DyFₓ is used.

(8) An organic metal compound of Cu is added to the solution under the condition of not changing the solution structure.

The diffraction pattern of a solution or a film formed by drying the solution had a plurality of peaks with a half width of 1° or greater (2° to 10°). This indicates that an inter-atom distance between the additive element and fluorine or between metal elements is different from that of REₙFₘ, and the crystal structure is also different from that of REₙFₘ and REₙ(F,O,C)ₘ. In this case, RE represents a rare earth element, F represents fluorine, O represents oxygen, C represents carbon and n or m is a positive integer. The ratio for fluorine, oxygen, and carbon is different depending on the product, and fluoride and oxygen are more than carbon at the outermost surface of the sintered magnet. Since the half width is 1° or greater, the inter-atom distance does not show a constant value as in usual metal crystals but has a certain distribution.

Such a distribution is formed because other atoms are arranged at the periphery of the atom of the metal element or the fluorine element described above in a manner different from that in the compound described above, and such atoms mainly comprise hydrogen, carbon, and oxygen.

When an external energy is supplied, for example, by heating, atoms such as hydrogen, carbon and oxygen move easily to change the structure and also change the fluidity. The X-ray diffraction pattern of the sol or gel comprises peaks having a half width of 1° or greater and the structural change is observed by heat treatment, and a portion of the diffraction pattern of REₙFₘ or REₙ(F,O,C)ₘ appears. Even when Cu is added, it has no long periodical structure in the solution. The diffraction peak of REₙFₘ has a narrower half width than the diffraction peak of the sol or the gel.

To increase the fluidity of the solution and making the coating thickness uniform, it is important that at least one peak having a half width of 1° or greater is present in the diffraction pattern of the solution. The peak with the half width of 1° or greater, and the peak of the diffraction pattern of REₙFₘ or the oxyfluoride compound may be contained. In the case where only the diffraction pattern of REₙFₘ or oxyfluoride compound, or the diffraction pattern of 1° or less are observed mainly in the diffraction pattern of the solution, since a solid phase which is not the sol or gel is mixed in the solution, fluidity is worsened. Then, such a solution is used and then coated to Nd₂Fe₁₄B (referred to simply as NdFeB).

(1) A sintered material of NdFeB (10×10×10 mm³) is compression molded at a room temperature, and impregnated during a process for forming a DyF type coating film and methanol as a solvent is removed from the block at a reduced pressure of 2 to 5 Torr.

(2) The procedure (1) described above is repeated for once to five times and heat treatment is applied within a temperature range from 400° C. to 110° C. for 0.5 to 5 hours.

(3) A pulse magnetic field at 30 kOe or more is applied in the anisotropic direction of the anisotropic magnet formed with the surface coating film in the procedure (2) described above.

The magnetized molding material is sandwiched between magnetic poles of a DC M-H loop measuring equipment such that the magnetizing direction of the molding material is aligned with the direction of applying the magnetic field, and a magnetic field is applied between the magnetic poles to measure a demagnetization curve. An FeCo alloy is used for the pole piece of the magnetic pole that applies the magnetic field to the magnetized molding material, and the value of the magnetization is calibrated by using a pure Ni sample and a pure Fe sample of an identical shape.

As a result, the coercive force of the block of the sintered NdFeB material formed with the Dy fluoride coating film is increased from 1.1 times to 3 times. A short range structure is observed in the vicinity of Cu added to the solution by the removal of the solvent and this is diffused together with the solution constituent element along the grain boundary of the sintered magnet by a further heat treatment.

Cu tends to segregate together with a portion of the solution constituent element in the vicinity of the grain boundary. The composition of the sintered magnet having a high coercive force shows a trend that the concentration of the element constituting the fluoride solution is higher at the outer periphery of the magnet and lower at the central portion of the magnet. This is because when the fluoride solution containing the additive element is coated and dried to the outside of the sintered magnet block, diffusion proceeds along the vicinity of the grain boundary, along with the growth of the fluoride or the oxyfluoride containing the additive element and having the short range structure.

That is, in the sintered magnet block, concentration gradient of fluorine and Cu is observed from the outer periphery (including also fluoride at the outermost periphery) to the inside. When an element having an atom number of 18 to 86 other than Cu is added to one of fluoride, oxide or oxyfluoride containing at least one rare earth element in a slurry state, improvement for the magnetic properties such as obtainability of higher coercive force than in the case where they are not added could be confirmed.

The role of the additive elements is one of the followings:
(1) segregating in the vicinity of the grain boundary to lower the boundary energy,
(2) enhancing lattice matching of the grain boundary,
(3) decreasing defects at the grain boundary,
(4) promoting grain boundary diffusion of rare earth element, etc.,
(5) increasing magnetic anisotropy energy in the vicinity of the grain boundary,
(6) making the boundary to the fluoride, oxyfluoride or fluoride carbonate of the cubic structure smooth,
(7) enhancing anisotropy of the rare earth element,
(8) removing oxygen from the parent phase,
(9) increasing curie temperature of the parent phase,
(10) segregating additive element containing Cu around the grain boundary as the center to make the grain boundary phase non-magnet,
(11) segregating additive elements to a further outside of the fluoride or oxyfluoride that grows at the outermost periphery of the sintered magnet thereby contributing to the improvement of the corrosion resistance and the control for the grain boundary composition, and
(12) weakly bonding at the boundary with the magnetic moment of the parent phase.

As the result thereof, it is recognized one of the effects of increasing the coercive force, improving the squareness of a demagnetization curve, increasing the residual magnetic flux density, increasing the energy product, increasing the curie temperature, decreasing the magnetizing magnetic field, decreasing the temperature dependence of the coercive force or the residual magnetic flux density, improving the corrosion resistance, increasing the specific resistivity, or decreasing the thermal demagnetization ratio.

A transition metal element may be usable as the additive element instead of Cu, and the concentration distribution thereof tends to decrease from the outer periphery to the inside of the sintered magnet and increase at the grain boundary on the average. The width of the grain boundary tends to be different between the vicinity of the grain boundary triple junction and a place apart from the grain boundary triple junction, and it shows a trend that the width is larger and the concentration is higher in the vicinity of the grain boundary triple junction. The transition metal additive element tends to be segregated at the grain boundary phase, the end of the grain boundary, or at the outer periphery in the grain from the grain boundary to the inside of the grain (on the side of the grain boundary).

Since the additive elements are thermally diffused after the treatment by using the solution, they have a compositional distribution different from that the elements added previously to the sintered magnet, and reach a high concentration in the vicinity of the grain boundary where fluorine or rare earth element is segregated, segregation of the previously added element is observed at the grain boundary where fluorine is less segregated, and average concentration gradient appears from the outside to the inside (on the side of the magnet) of the fluoride at the outermost surface of the magnet block. In the case where the concentration of the additive element in the solution is low, this can be confirmed as the concentration gradient or the concentration difference.

As described above, when the additive element is added to the solution, and the properties of the sintered magnet are improved by the heat treatment after coating the solution to the magnet block, the sintered magnet has features as described below.

(1) The concentration gradient or the average concentration difference of the transition metal element is observed in the vicinity of the fluoride layer at the outermost surface.

(2) Segregation of the transition metal element together with fluorine is present in the vicinity of the grain boundary.

(3) The fluorine concentration is high at the grain boundary phase, the fluorine concentration is low at the outside of the grain boundary phase, segregation of the transition metal element is observed in the vicinity of a place where the difference of the fluorine concentration is present, and average concentration gradient or the concentration difference is observed from the surface to the inside of the magnet block.

(4) A fluoride layer or an oxyfluoride layer containing the transition metal element, fluorine, and carbon grows at the outermost surface of the sintered magnet.

When a rotor is manufactured by bonding an NdFeB type sintered magnet comprising an Nd₂Fe₁₄B structure as a main phase prepared as described above with a laminated electromagnetic steel sheet, laminated amorphous or dust core, it is previously inserted to a position for inserting the magnet.

FIG. 2 is a schematic cross-sectional view perpendicular to the axial direction of a motor. A motor includes a rotor 100 and a stator 2, the stator includes a core back 5 and teeth 4, and each of coils 8a, 8b, and 8c of a coil group (U phase windings 8a, V phase windings 8b, W phase windings 8c in three phase windings) is inserted into the coil insertion position 7 between the teeth 4. A rotor insertion portion 10 for housing the rotor is defined from the top end 9 of the teeth 4 to the center of the shaft, and the rotor 100 is inserted to the position. A plurality of sintered magnets 201 are inserted per one pole at the outer circumference of the rotor 100.

The performance required for the sintered magnet varies depending on the working circumstance temperature, magnetic field strength, magnetic field waveform, frequency, induced voltage, torque, cogging torque, vibration, noise, etc.

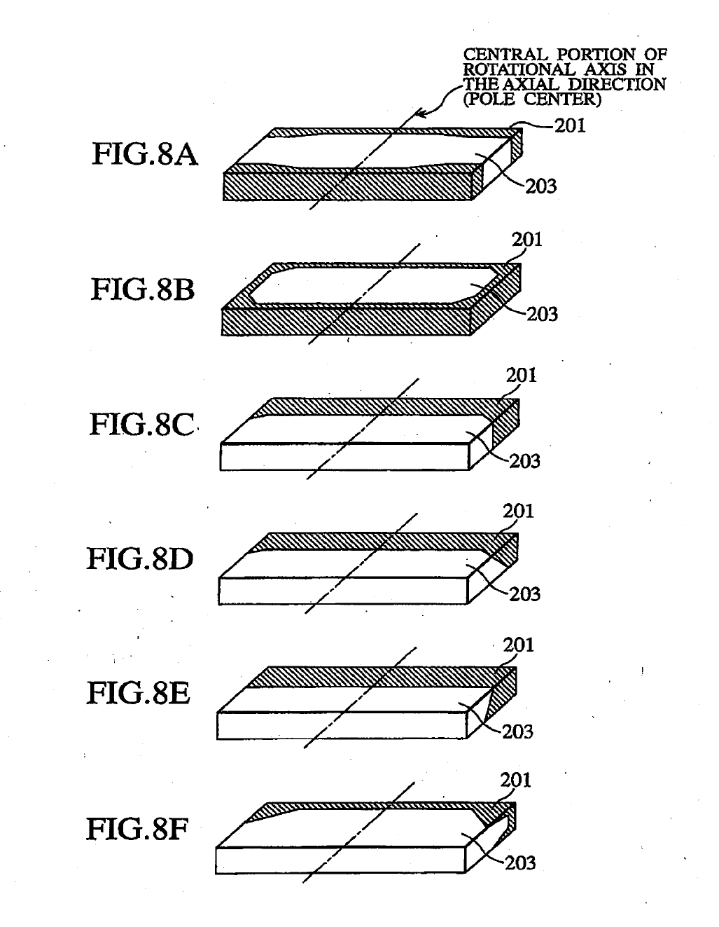

FIG. 8 shows sintered magnets applied with various fluoride treatments. The sintered magnets are manufactured by the steps described above to be used for the sintered magnet 201 of the rotor 100 shown in FIG. 2. The sintered magnet in FIG. 8 is a cubic in which the longer side is in parallel with the axial direction, and the direction substantially in parallel with the shorter side is the anisotropic direction, that is, the magnetizing direction.

In FIG. 8, a portion 203 not treated with a fluoride and a portion 201 treated with the fluoride are formed in the sintered magnet. In each of the sintered magnets, the fluoride treatment is applied to at least one corner or side. The portion 203 not treated with the fluoride and the portion 201 treated with the fluoride correspond to a low coercive force portion and a high coercive force portion respectively.

The boundary between the fluoride treated portion 201 and the not treated portion 203 is a linear or a curve in which a concentration gradient of a coating material such as fluorine is present for a distance from 10 times to 1000 times of the average crystal grain. The width for the boundary ranges from 10 μm to 10,000 μm. In the fluoride treatment, after coating with the solution, it is diffused by heating as described above. In addition to the method of applying the heat treatment within a temperature range from 400° C. to 1100° C. for 0.5 to 5 hours, the heat treatment includes a method of generating heat from the fluoride by using electromagnetic waves. The latter method can heat only the vicinity of a localized portion selectively to a high temperature and can suppress degradation of the magnetic properties for the not-treated portion 203 by the heat treatment.

In the sintered magnet in FIG. 8A, both ends in the direction perpendicular to the anisotropy are treated by a fluoride. The fluoride treated portion 201 is narrowed in the axially central portion of the rotational axis and is widened at both ends apart from the axially central portion. This is because the corner of the sintered magnet is considered to be a portion sensitive to the demagnetization field.

In the sintered magnet shown in FIG. 8B, four corners and all surfaces in parallel with the anisotropic direction are applied with the fluoride treatment. The not fluoride treated portion 203 is only at the central portion of two planes perpendicular to the anisotropic direction, which increases the coercive force in a portion sensitive to the demagnetization field at the corners and the periphery of the side.

FIG. 8C shows a sintered magnet in which one of four planes in parallel with the anisotropic direction is entirely applied with the fluoride treatment and a portion of the remaining plane is applied with the fluoride treatment. Such a sintered magnet is applicable as a magnet which is less demagnetized when a demagnetization field is applied in the vicinity of one side of the sintered magnet and it is effective in the case where it is disposed being slanted from the radial direction in view of the center on the cross section where the anisotropic direction of the sintered magnet is perpendicular to the axial direction of the rotor.

Referring to FIG. 8D, the amount of fluoride treatment is decreased by making the fluoride treatment region smaller than that of the sintered magnet in FIG. 8C. Referring to FIG. 8D, the area of the fluoride treated portion 201 is changed in the plane in parallel with the anisotropy, and the boundary between the fluoride treated portion 201 and the not fluoride treated portion 203 is slanted from the anisotropic direction. In the sintered magnet described above, two corners among the four corners of the sintered magnet and one of planes parallel with the anisotropic direction of the sintered magnet are applied with the fluoride treatment and this is effective particularly when the vicinity of one longer side is provided with high coercive force.

In FIG. 8E, the area of the fluoride treated portion is different at two planes perpendicular to the anisotropy, and this is effective when the magnet is designed such that magnetization of the sintered magnet is less reversed on the outer periphery of the rotor relative to the demagnetization field, by disposing the region of the larger area to the outer periphery of the rotor.

In FIG. 8F, the fluoride treated portion 201 is formed by the solution treatment when four corners and the vicinity of two sides of the sintered magnet are made so as to have high coercive force among eight corners and six sides of the sintered magnet.

A rotor of decreasing the amount of use of Dy can be manufactured by disposing 6 types of the sintered magnets in FIG. 8 as described above to the sintered magnet insertion position 201 in FIG. 2.

### Embodiment 3

When a rotor is manufactured by bonding an NdFeB type sintered magnet comprising an Nd₂Fe₁₄B structure as a main phase with a laminated electromagnetic steel sheet, laminated amorphous or dust core, the magnet is previously inserted to a position for inserting the magnet.

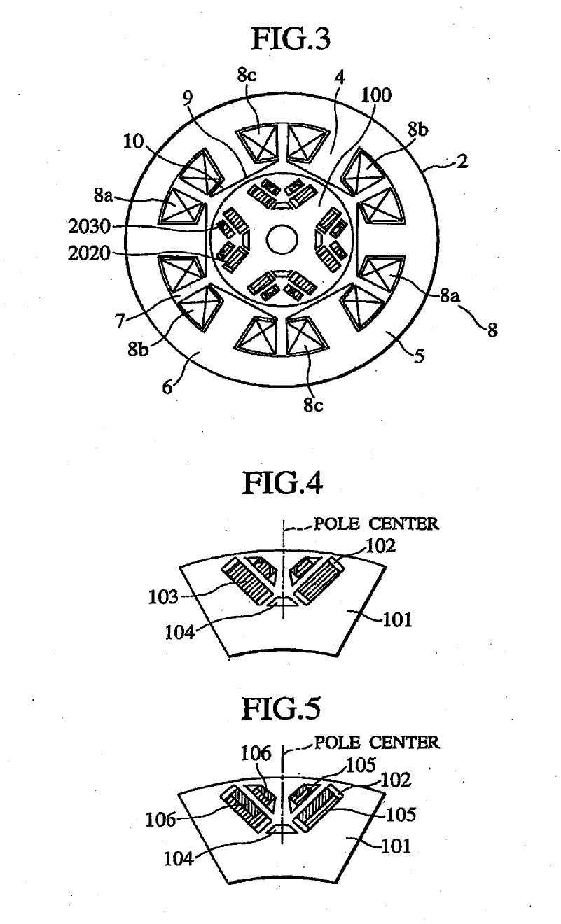

FIG. 3 is a schematic cross-sectional view perpendicular to the axial direction of a motor. A motor includes a rotor 100 and a stator 2, the stator includes a core back 5 and teeth 4, and each of coils 8a, 8b, and 8c of a coil group (U phase windings 8a, V phase windings 8b, W phase windings 8c in three phase windings) is inserted into the coil insertion position 7 between the teeth 4. A rotor insertion portion 10 for housing the rotor is defined from the top end 9 of the teeth 4 to the center of the shaft, and the rotor 100 is inserted to the position.

A plurality of sintered magnets per one pole are inserted to the outer periphery of the rotor 100.

The sintered magnet has a fluoride treated portion 2030 and not treated portion 2020, and a portion of a sintered magnet block is heat treated after impregnation into a fluoride solution to provide a high coercive force.

As shown in FIG. 3, the fluoride treated portion 2030 is not bilaterally symmetric when viewing a pole in the radial direction from the center for one pole, and the fluoride coating positions for the corner portion of sintered magnet are asymmetrical. Even when the fluoride treatment is applied symmetrically, the concentration of the element such as Dy necessary for increasing the coercive force can be decreased by forming the coercive force distribution bilaterally asymmetric. The performance required for the sintered magnet varies depending, for example, on the working circumstance temperature, magnetic field strength, magnetic field waveform, frequency, induced voltage, torque, cogging torque, vibration, and noise.

FIG. 8 shows sintered magnets applied with various fluoride treatments. For using the sintered magnets as the sintered magnet 201 of the rotor 100 in FIG. 2, they are manufactured by the following steps. The portion 203 applied with the fluoride treatment has features as described below.

(1) A phase containing at least 0.1 at % of fluorine is formed.

(2) A portion of fluorine atoms is bonded with Nd.

(3) Fluorine and Nd are unevenly distributed.

(4) Fluorine, Nd and carbon are present each in a great amount at the grain boundary.

(5) A compound layer containing a fluorine compound, oxygen, or carbon grows at the outermost periphery while being partially in adjacent with the Cu segregation layer.

(6) Iron is contained in a portion of the fluorine compound.

(7) The width for the grain boundary phase is larger on the outer side of the sintered magnet and from 1 to 20 nm on the average. The width of the grain boundary phase is widened in the vicinity of the grain boundary triple junction.

(8) At least one grain of high fluorine content grows in the crystal grains of the parent phase.

(9) The coercive force is greater by from 1.1 to 2 times compared with that in the portion not applied with the fluoride treatment.

(10) Hk is greater by from 1.05 to 1.1 times compared with the not fluoride treated portion.

The fluoride treated portion having such features is prepared as described below. A treating solution for forming (Dy_{0.9}Cu_{0.1})Fₓ (x=1 to 3) rare earth fluoride coating film is prepared as described below.

(1) 4 g of Dy nitrate is introduced into 100 mL of water and dissolved completely by using a shaker or a supersonic stirrer.

(2) Hydrofluoric acid diluted to 10% is added gradually by an equivalent amount for the chemical reaction of forming DyFₓ (x=1 to 3).

(3) A solution in which DyFₓ (x=1 to 3) is formed as gelled precipitates is stirred for one hour or more by using a supersonic stirrer.

(4) After centrifugal separation at the number of rotation of 6,000 to 10,000 r.p.m., supernatants are removed and a substantially equal amount of methanol is added.

(5) After stirring a methanol solution containing a gelled DyF cluster to form a complete liquid suspension, it is stirred for one hour or more by using a supersonic stirrer.

(6) The procedures (4), (5) are repeated for three to ten times till anions such as acetate ions or nitrate ions are no more detected.

(7) In the case of the DyF type solution, a substantially transparent sol-like DyFₓ is formed. As the treating solution, a methanol solution containing 1 g/5 mL of DyFₓ is used.

(8) An organic metal compound of Cu is added to the solution under the condition of not changing the solution structure.

The diffraction pattern of a solution or a film formed by drying the solution has a plurality of peaks with a half width of 0.5° or greater (0.5° to 10°). This indicates that an inter-atom distance between the additive element and fluorine or between metal elements is different from that of REₙFₘ, and the crystal structure is also different from that of REₙFₘ and REₙFₘOₕCᵢ. In this case, RE represents a rare earth element, F represents fluorine, O represents oxygen, C represents carbon, and n, m, h and i are a positive integers. Since the half width is 0.5° or greater, the inter-atom distance does not have a constant value as in usual metal crystals but has a certain distribution.

Such a distribution is formed because other atoms are arranged at the periphery of the atom of metal element or the fluorine element described above in a manner different from that in the compound described above, and such atoms mainly comprise hydrogen, carbon, and oxygen.

When an external energy is supplied, for example, by heating, atoms such as hydrogen, carbon and oxygen move easily to change the structure and also change the fluidity. The X-ray diffraction pattern of the sol or gel has peaks having a half width of 1° or greater and the structural change is observed by heat treatment, and a portion of the diffraction pattern of REₙFₘ or REₙFₘOₕCᵢ appears. Even when Cu is added, it has no long periodical structure in the solution. The diffraction peak of REₙFₘ has a narrower half width than the diffraction peak of the sol or the gel.

To increase the fluidity of the solution and making the coating thickness uniform, it is important that at least one peak having a half width of 1° or greater is present in the diffraction pattern of the solution. The peak with the half width of 1° or greater, and the peak of the diffraction pattern of REₙFₘ or the oxyfluoride compound may be contained. In the case where only the diffraction pattern of REₙFₘ or the oxyfluoride compound, or the diffraction pattern of 1° or less are observed, mainly in the diffraction pattern of the solution, since a solid phase which is not the sol or gel is mixed in the solution, fluidity is worsened. Then, such a solution is used and coated to Nd₂Fe₁₄B (simply referred to as NdFeB).

(1) A sintered material of NdFeB (10×10×10 mm³) is compression molded at a room temperature, and impregnated during a process for forming a DyF type coating film and methanol as a solvent is removed from the block at a reduced pressure of 2 to 5 Torr.

(2) The procedure (1) described above is repeated for once to five times and a heat treatment is applied within a temperature range from 400° C. to 1100° C. for 0.5 to 5 hours.

(3) A pulse magnetic field at 30 kOe or more is applied in the anisotropic direction of the anisotropic magnet formed with the surface coating film in the procedure (2) described above.

The magnetized molding material is sandwiched between magnetic poles of a DC M-H loop measuring equipment such that the magnetizing direction of the molding material is aligned with the direction of applying the magnetic field, and a magnetic field is applied between the magnetic poles to measure a demagnetization curve. An FeCo alloy is used for the pole piece of the magnetic pole that applies the magnetic field to the magnetized molding material, and the value of the magnetization is calibrated by using a pure Ni sample and a pure Fe sample of an identical shape.

As a result, the coercive force of the block of the sintered NdFeB material formed with the Dy fluoride coating film is increased from 1.1 times to 4 times. A short range structure is observed in the vicinity of Cu added to the solution by the removal of the solvent and Cu diffuses together with the solution constituent element along the grain boundary of the sintered magnet by a further heat treatment.

Cu tends to segregate together with a portion of the solution constituent element in the vicinity the grain boundary. The composition of the sintered magnet having a high coercive force shows a trend that the concentration of the element constituting the fluoride solution is higher at the outer periphery of the magnet and lower at the central portion of the magnet. This is because when the fluoride solution containing the additive element is coated and dried to the outside of the sintered magnet block, diffusion proceeds along the vicinity of the grain boundary together with the growth of the fluoride or the oxyfluoride containing the additive element and having the short range structure.

That is, in the sintered magnet block, concentration gradient of fluorine and Cu is observed from the outer periphery (including also fluoride at the outermost periphery) to the inside. When an element having an atom number of 18 to 86 other than Cu is added to one of fluoride, oxide, or oxyfluoride containing at least one rare earth element in a slurry state, improvement of magnetic properties, for example, obtainability of higher coercive force than that in the case of not adding them can be confirmed.

The role of the additive elements is one of the followings:
(1) segregating in the vicinity of the grain boundary to lower the boundary energy,
(2) enhancing lattice matching of the grain boundary,
(3) decreasing defects at the grain boundary,
(4) promoting grain boundary diffusion of rare earth element, etc.,
(5) increasing magnetic anisotropy energy in the vicinity of the grain boundary,
(6) making the boundary to the fluoride, oxyfluoride or fluoride carbonate of the cubic structure smooth,
(7) enhancing anisotropy of the rare earth element,
(8) removing oxygen from the parent phase,
(9) increasing the curie temperature of the parent phase,
(10) segregating while containing Cu around the center of the grain boundary, thereby making the grain boundary phase non-magnetic,
(11) segregating to a further outside of the fluoride or oxyfluoride that grows at the outermost periphery of the sintered magnet, thereby contributing to the improvement of the corrosion resistance and the control for the grain boundary composition and,
(12) weakly bonding at the boundary with the magnetic moment of the parent phase.

As the result thereof, it is recognized one of the effects of increasing the coercive force, improving the squareness of a demagnetization curve, increasing the residual magnetic flux density, increasing the energy product, increasing the curie temperature, decreasing the magnetizing magnetic field, decreasing the temperature dependence of the coercive force or the residual magnetic flux density, improving the corrosion resistance, increasing the specific resistivity, or decreasing the thermal demagnetization ratio.

A transition metal element may be usable as the additive element instead of Cu, and the concentration distribution thereof tends to decrease from the outer periphery to the inside of the sintered magnet and increase at the grain boundary on the average. The width of the grain boundary tends to be different between the vicinity of the grain boundary triple junction and a place apart from the grain boundary triple junction, and it shows a trend that the width is larger and the concentration is higher in the vicinity of the grain boundary triple junction. The transition metal additive element tends to be segregated at the grain boundary phase, the end of the grain boundary, or at the outer periphery in the grain from the grain boundary to the inside of the grain (on the side of the grain boundary).

Since the additive elements are thermally diffused after the treatment by using the solution, they have a compositional distribution different from that of the elements added previously to the sintered magnet, and reach a high concentration in the vicinity of the grain boundary where fluorine or rare earth element is segregated, segregation of the previously added element is observed at the grain boundary where fluorine is less segregated, and average concentration gradient appears from the outside to the inside (on the side of the magnet) of the fluoride at the outermost surface of the magnet block. In the case where the concentration of the additive element in the solution is low, this can be confirmed as the concentration gradient or the concentration difference.

As described above, when the additive element is added to the solution, and the properties of the sintered magnet are improved by the heat treatment after coating the solution to the magnet block, the sintered magnet has features as described below.

(1) The concentration gradient or the average concentration difference of the transition metal element is observed in the vicinity of the fluoride layer at the outermost surface.

(2) Segregation of the transition metal element together with fluorine is present in the vicinity of the grain boundary.

(3) The fluorine concentration is high at the grain boundary phase, the fluorine concentration is low at the outside of the grain boundary phase, segregation of the transition metal element is observed in the vicinity of a place where the difference of the fluorine concentration is present, and average concentration gradient or the concentration difference is observed from the surface to the inside of the magnet block.

(4) A fluoride layer or an oxyfluoride layer containing the transition metal element, fluorine, and carbon grows on the outermost surface of the sintered magnet.

The sintered magnet applied with the fluoride treatment as described above can be shown by the composition described below.

The sintered magnet is obtained by diffusing an ingredient G (G represents an element selected by one or more from each of transition metal elements and rare earth elements, or an element selected by one or more from each of transition metal elements and alkaline earth metal elements) and a fluorine atom to an R—Fe—B type (where R represents a rare earth element) from the surface thereof, and has the composition represented by the following formula (1) or (2):

RₐG_{b}T_{c}A_{d}FₑO_{f}M_{g} (1)

(R·G)_{a+b}T_{c}A_{d}FₑO_{f}M_{g} (2)

(where R represents one or more elements selected from rare earth elements, M represents an element except for C and B of group 2 to group 16 except for rare earth elements present in the sintered magnet before coating a solution containing fluorine, G represents an element selected by one or more from each of transition metal elements and rare earth elements, or an element selected by one or more from each of transition metal elements and alkaline earth metal elements, in which R and G may contain an identical element, providing that the composition is represented by the formula (1) when R and G do not contain an identical element and represented by the formula (2) when R and G contain the identical element, T represents one or more elements selected from Fe and Co, A represents one or more element selected from B (boron) and C (carbon), a to g each represents at % of an alloy in which a and b are expressed as: 10≦a≦15 and 0.005≦b≦2 in the case of the formula (1), and 10.005≦a+b≦17 in the case of the formula (2), 3≦d≦15, 0.01≦e≦4, 0.04≦f≦4, and 0.01≦g≦11, C being the balance).

In the rare earth permanent magnet, at least one of F and the transition metal element as the constituent elements thereof is distributed such that contained concentration increases from the center of the magnet to the surface of the magnet on the average, the concentration of G/(R+G) contained in the crystal grain boundary is higher than the concentration of G/(R+G) in the main phase crystal grains on the average in the crystal grain boundary surrounding the periphery of the main phase crystal grain comprising an (R, G)₂T₁₄A tetragonal system in the sintered magnet, oxyfluoride, fluoride, or fluoride carbonate of a cubic structure of R and G is present in the crystal grain boundary in a region for at least 10 μm depth from the surface of the magnet, and the coercive force in the vicinity of the magnet surface layer is higher than that in the inside, the concentration gradient of the transition metal element is observed from the surface to the center of the sintered magnet as one of the feature thereof.

### Embodiment 4

When a rotor is manufactured by bonding an NdFeB sintered magnet having an Nd₂Fe₁₄B structure as a main phase with a laminated electromagnetic steel sheet, a laminated amorphous or dust core, the magnet is previously inserted to the insertion portion.

FIG. 4 to FIG. 7 show schematic cross sectional views of one pole of a rotor 101 perpendicular to the axial direction of a motor. The sintered magnet has a fluoride treated portion 106 and a not treated portion 105, and a portion of the sintered magnet block is impregnated in a fluoride solution and heat treated to provide a high coercive force.

As shown in FIG. 4 to FIG. 6, the fluoride treated portion 106 is not bilaterally symmetric when viewing the pole in the radial direction from the center for a pole and the fluoride coating position at the corner of the sintered magnet is asymmetric. The concentration of the element such as Dy necessary for increasing the coercive force can be decreased by making the coercive force distribution bilaterally asymmetric even when applying a fluoride treatment bilaterally symmetrically. A space 104 is formed at the center of the pole for ensuring reluctance torque. The performance required for the sintered magnet varies, for example, depending on working circumstance temperature, magnetic field strength, magnetic field waveform, frequency, induced voltage, torque, cogging torque, vibration and noise.

In FIG. 4, two magnets, i.e., a sintered magnet applied with the fluoride treatment on one end and a sintered magnet applied with the fluoride treatment on two ends are disposed on the outer circumference. Since the decrease of the residual magnetic flux density by the fluoride treatment is as small as 0.2% or less, the waveform for the surface magnetic flux density that can be measured on the outer periphery of the rotor does not substantially change from the case of not applying the fluoride treatment. Accordingly, the fluoride treated portion gives less effect on the induced voltage waveform and resource saving and high efficiency motor property can be made compatible by applying the fluoride treatment only for the portion where the demagnetization field is large.

In FIG. 5, the fluoride treatment is applied on the outer circumference and the inner circumference and at least one corner is provided with high coercive force by the fluoride treatment for all of the magnets. The fluoride treated portion 106 can be provided with high coercive force by optionally applying coating and diffusion on the outer periphery relative to the not-treated portion 105 or at the corner.

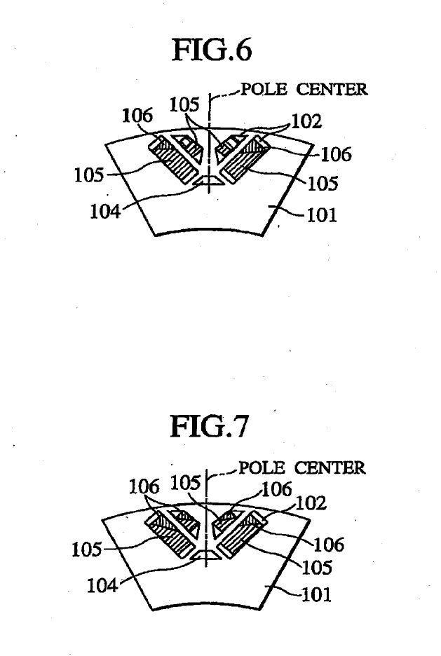

Further, in the sintered magnet shown in FIG. 6, the boundary between the not treated portion 105 and the fluoride treated portion 106 is not in parallel with but formed at an angle with the side of the sintered magnet. The amount of use of the rare earth element can be decreased by restricting the region for the fluoride treatment as described above.

Further, in FIG. 7, all of four magnets have a fluoride treated portion 106 only at the corner on the outer circumference and not treated portion 105 at other portions. Such a magnet applied with the fluoride treatment only at the corners with the boundary not in parallel with the side of the cubic can be prepared without mask by using a solution.

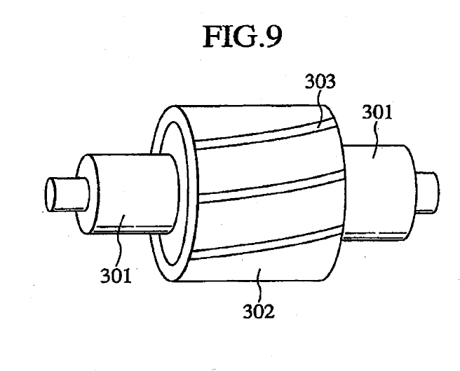

Further, FIG. 9 is a perspective view of a rotor in which a sintered magnet is disposed on the outer periphery of a shaft 301 and has a fluoride treated portion 303 and a not treated portion 302. Noises or vibrations of the motor can be decreased by axially slanting the fluoride treated portion 303.

The sintered magnet partially applied with the fluoride treatment as described above can be manufactured by the following methods. An example is shown below. At first a fluoride solution is prepared, the solution is coated and then heated to diffuse the fluoride to the inside of the sintered magnet.

A treating solution for forming a (Dy_{0.9}Cu_{0.1})Fₓ (x=1 to 3) rare earth fluoride coating film is prepared as described below.

(1) 4 g of Dy nitrate is introduced into 100 mL of water and dissolved completely by using a shaker or a supersonic stirrer.

(2) A hydrofluoric acid diluted to 10% is added gradually by an equivalent amount of the chemical reaction forming DyFₓ (x=1 to 3).

(3) A solution in which DyFₓ (x=1 to 3) is formed as gelled precipitates is stirred for one hour or more by using a supersonic stirrer.

(4) After centrifugal separation at the number of rotation of 6,000 to 10,000 r.p.m., supernatants are removed and a substantially equal amount of methanol is added.

(5) After stirring a methanol solution containing gelled DyF cluster to form a complete liquid suspension, it is stirred for one hour or more by using a supersonic stirrer.

(6) The operations (4), (5) are repeated three to ten times till anions such as acetate ions or nitrate ions are no more detected.

(7) In the case of the DyF type solution, a substantially transparent sol-like DyFₓ is formed. As the treating solution, a methanol solution containing 1 g/5 mL of DyFₓ is used.

(8) An organic metal compound of Co is added to the solution under the condition not changing the solution structure.

The diffraction pattern of the solution or a film formed by drying the solution has a plurality of peaks having a half width of 0.5° or greater (from 0.5° to 10°). This indicates that the inter-atom distance between the additive elements and fluorine or between metal elements is different from REₙ Fₘ and also the crystal structure is different from REₙFₘ or REₙFₘOₕCᵢ. RE represents a rare earth element, F represents fluorine, O represents oxygen, C represents carbon and n, m, h and i are positive integers.

Since the half width is 0.5° or greater, the inter-atom distance does not show a constant value as in usual metal crystals but has a certain distribution. Such distribution is formed because other atoms are arranged at the periphery of the atom of the metal element or the fluorine element described above in a manner different from the compound described above. The atom mainly comprises hydrogen, carbon, and oxygen, and the atoms of hydrogen, carbon, oxygen, etc. move easily to change the structure and also change the fluidity by applying external energy such as heating.

The X-ray diffraction pattern of the sol or the gel has a peak having the half width of 1° or greater, and a structural change is observed by the heat treatment and a portion of the diffraction pattern of REₙFₘ or REₙFₘOₕCᵢ appears. Even when Co is added, it does not have a long periodical structure in the solvent. The half width of the diffraction peak of REₙFₘ is narrower than that of the diffraction peak for the sol or gel described above.

For improving the fluidity of the solution and making the coating thickness uniform, it is important that at least one peak having the half width of 1° or greater is observed in the diffraction pattern of the solution. The peak with the half width of 1° or greater, and the peak of the REₙFₘ diffraction pattern or the peak of the oxyfluoride compound may also be contained. When only the diffraction pattern of REₙFₘ, the oxyfluoride compounds, or the diffraction pattern of 1° or less is mainly observed in the diffraction pattern of the solution, the fluidity is worsened since a solid phase which is not the sol or gel is mixed in the solution. Then, such a solution is used and coated to Nd₂Fe₁₄B (hereinafter simply referred to as NdFeB).

(1) An NdFeB sintered material (10×10×10 mm³) is compression molded at a room temperature, and impregnated during a DyF type coating film forming process and methanol as the solvent is removed under a reduced pressure of 2 to 5 Torr from the block.

(2) The procedure (1) is repeated once to five times and a heat treatment is applied within a temperature range from 400° C. to 1100° C. for 0.5 to 5 hours.

(3) A pulse magnetic field at 30 kOe or higher is applied in the anisotropic direction of the anisotropic magnet formed with a surface coating film in (2) described above.

The magnetized molding material is sandwiched between magnetic poles of a DC M-H loop measuring equipment such that the magnetizing direction of the molding material is aligned with the direction of applying the magnetic field and a magnetic field is applied between the magnetic poles to measure the demagnetization curve. An FeCo alloy is used for a pole piece of the magnetic pole that applies the magnetic field to the magnetized molding material, and the value for the magnetization is calibrated by using a pure Ni sample and a pure Fe sample of an identical shape.

As a result, the coercive force of the block of the NdFeB sintered material formed with the Dy fluoride coating film is increased by 1.1 to 4 times. A short range structure is observed in the vicinity of Co added to the solution by the removal of the solvent, and Co diffuses together with solution constituent elements along the grain boundary of the sintered magnet by further heat treatment. Co tends to segregate together with a portion of the solution constituent elements in the vicinity of the grain boundary.

The composition of the sintered magnet having a high coercive force shows a trend that the concentration of the element constituting the fluoride solution is higher at the outer periphery of the magnet and lower at the central portion of the magnet. This is because when the fluoride solution containing the additive element is coated and dried at the outside of the sintered magnet block, a fluoride or oxyfluoride containing the additive element and having the short range structure grows and diffusion thereof proceeds along the vicinity of the grain boundary.

That is, in the sintered magnet block, concentration gradient of fluorine and Co is recognized from the outer periphery (also including the fluoride at the outermost periphery) to the inside thereof. When an element other than Co and having an atom number from 18 to 86 is added to one of fluorides, oxides, or oxyfluorides containing at least one of the rare earth elements in the form of slurry,.improvement in the magnetic properties can be confirmed such that higher coercive force than that in the case with no addition is obtained.

The role of the additive elements is one of the followings:
(1) segregating in the vicinity of the grain boundary to lower the boundary energy,
(2) enhancing the lattice matching at the grain boundary,
(3) reducing defects at the grain boundary
(4) promote grain boundary diffusion such as rare earth element, etc.,
(5) enhancing the magnetic anisotropy energy in the vicinity of the grain boundary,
(6) making the boundary to the fluoride, oxyfluoride or fluoride carbonate smooth,
(7) enhancing the anisotropy of the rare earth element,
(8) removing oxygen from the parent phase,
(9) increasing the curie temperature of the parent phase,
(10) segregating while containing Co around the center of the grain boundary, thereby making the grain boundary phase non-magnetic,
(11) segregating to a further outside of the fluoride or the oxyfluoride growing to the outermost circumference of the sintered magnet, and contribute, for example, to the improvement of the corrosion resistance and the control for the grain boundary composition.
(12) weakly bonding at the boundary with the magnetic moment of the parent phase.

As a result thereof, it can be recognized one of the effects of increase of the coercive force, enhancement of the squareness of the demagnetization curve, increase of the residual magnetic flux density, increase of the energy product, increase of the curie temperature, decrease of the magnetizing magnetic field, decrease of the temperature dependence of the coercive force or the residual magnetic flux density, improvement of the corrosion resistance, increase of the specific resistivity, and decrease of the thermal demagnetization ratio.

Further, a transition metal element may be usable as the additive element instead of Co, and the concentration distribution thereof shows a trend that the concentration decreases on the average from the outer periphery to the inside of the sintered magnet and shows a trend of reaching high concentration at the grain boundary. The width of the grain boundary tends to be different between the vicinity of the grain boundary triple junction and a place apart from the grain boundary triple junction, and the width and the concentration tend to increase in the vicinity of the grain boundary triple junction. The transition metal additive element tends to segregate at the grain boundary phase, the end of the grain boundary, or to the outer periphery in the grain from the grain boundary to the inside of the grain (on the side of the grain boundary).

Since the additive elements are diffused by heating after the treatment by using a solution, they have a compositional distribution different from that of the element added previously to the sintered magnet, and each high concentration in the vicinity of the grain boundary where the fluorine or the rare earth element is segregated, segregation of the previously added element is observed at the grain boundary where fluorine less segregates, and this develops as an average concentration gradient from the outside to the inside (on the side of the magnet) of the fluoride at the outermost surface of the magnet block. In the case where the concentration of the additive element is low in the solution, this can be confirmed as the concentration gradient or the concentration difference.

When the additive element is added to the solution to be coated to the magnet block so that the property of the sintered magnet is improved by the heat treatment, the features of the sintered magnet are as described below.

(1) The concentration gradient or the average concentration difference of the transition metal element is observed in the vicinity of the fluoride layer at the outermost surface.

(2) Segregation of the transition metal element together with fluorine in the vicinity of the grain boundary is observed.

(3) The fluorine concentration is high at the grain boundary phase and the fluorine concentration is low at the outside of the grain boundary phase, segregation of the transition metal element is observed in the vicinity where the fluorine concentration difference is observed, and the concentration gradient or the concentration difference on the average is observed from the surface to the inside of the magnet block.

(4) A fluoride layer or an oxyfluoride layer containing a transition metal element, fluorine and carbon grows on the outermost surface of the sintered magnet.

The sintered magnet applied with the fluoride treatment can be shown by the following composition.

A sintered magnet is obtained by diffusing an ingredient G (G represents an element selected by one or more from each of transition metal elements and rare earth elements, or an element selected by one or more from each of transition metal elements and alkaline earth metal elements) and a fluorine atom to an R—Fe—B type sintered magnet (R represents a rare earth element) from the surface thereof, and has the composition represented by the following formula (1) or (2):

RₐG_{b}T_{c}A_{d}FₑO_{f}M_{g} (1)

(R·G)_{a+b}T_{c}A_{d}FₑO_{f}M_{g} (2)

(where R represents one or more elements selected from rare earth elements, M represents an element except for C and B of group 2 to group 16 except for rare earth elements present in the sintered magnet before coating a solution containing fluorine, G represents an element selected by one or more from each of transition metal elements and rare earth elements, or an element selected by one or more from each of transition metal elements and alkaline earth metal elements, R and G may contain an identical element, providing that the composition is represented by the formula (1) when R and G do not contain an identical element and represented by the formula (2) when R and G contain the identical element, T represents one or more elements selected from Fe and Co, A represents one or more elements selected from B (boron) and C (carbon), a to g each represents an at % of an alloy in which a and b are represented as: 10≦a≦15 and 0.005≦b≦2 in the case of the formula (1), and 10.005≦a+b≦17 in the case of the formula (2), 3≦d≦15, 0.01≦e≦4, 0.04≦f≦4, and 0.01≦g≦11, with the balance of c).

In the rare earth permanent magnet described above, at least one of F and transition metal elements as the constituent element thereof is distributed such that the contained concentration increases on the average from the center of the magnet to the surface of the magnet and, in the crystal grain boundary surrounding the periphery of the main phase crystal grain comprising an (R, G)₂T₁₄A tetragonal system in the sintered magnet, the concentration of G/(R+G) contained in the crystal grain boundary is denser on the average than the concentration of G/(R+G) in the main phase crystal grains, oxyfluoride, fluoride, or fluoride carbonate having a cubic structure of R and G is present in the crystal grain boundary in a region at least by 10 μm depth from the surface of the magnet, and the coercive force in the vicinity of the magnet surface layer is higher than that in the inside of the magnet, the concentration gradient of the transition metal element is observed from the surface to the center of the sintered magnet as one of features thereof.

The fluoride treated portion can also be described as below by another description for the composition.

A sintered magnet is obtained by diffusing an ingredient G (G represents a metal element (at least one member of metal elements of group 3 to group 11 except for rare earth elements or elements of group 2, and group 12 to group 16 except for C and B), and one or more rare earth elements), and a fluorine atom to an R—Fe—B type (where R represents a rare earth element) from the surface thereof, and has the composition represented by the following formula (1) or (2):

RₐG_{b}T_{c}A_{d}FₑO_{f}M_{g} (1)

(R·G)_{a+b}T_{c}A_{d}FₑO_{f}M_{g} (2)

(where R represents one or more elements selected from rare earth elements, M represents an element except for C and B of group 2 to group 116 except for rare earth elements present in the sintered magnet before coating a solution containing fluorine, G represents an element selected by one or more from each of transition metal element and rare earth element (metal elements of group 3 to group 11 except for rare earth elements or elements of group 2 and group 12 to group 16 except for C and B), or an element selected by one or more from each of transition metal element and alkaline earth metal elements (metal elements of group 3 to group 11 except for rare earth elements or elements of group 2 and group 12 to group 16 except for C and B), R and G may contain an identical element, providing that the composition is represented by the formula (1) when R and G do not contain an identical element and represented by the formula (2) when R and G contain the identical element, T represents one or more elements selected from Fe and Co, A represents one or more elements selected from B (boron) and C (carbon), a to g each represents an at % of an alloy in which a and b are represented as: 10≦a≦15 and 0.005≦b≦2 in the case of the formula (1), and 10.005≦a+b≦17 in the case of the formula (2), 3≦d≦17, 0.01≦e≦10, 0.04≦f≦4, and 0.01≦g≦11, with the balance of c).

In the rare earth permanent magnet described above, at least one of F and metal elements (elements except for C and B of group 2 to group 116 except for rare earth elements) as the constituent element thereof is distributed such that the contained concentration increases on the average from the center of the magnet to the surface of the magnet and, in the crystal grain boundary surrounding the periphery of the main phase crystal grain comprising an (R, G)₂T₁₄A tetragonal system in the sintered magnet, the concentration of G/(R+G) contained in the crystal grain boundary is denser on the average than the concentration of G/(R+G) in the main phase crystal grains, an oxyfluoride, fluoride, or fluoride carbonate having a cubic structure of R and G is present in the crystal grain boundary in a region at least by 1 μm depth from the surface of the magnet, and the coercive force in the vicinity of the magnet surface layer is higher than that in the inside of the magnet, the concentration gradient or the concentration difference of the metal element (element excluding C and B of the group 2 to the group 116 excluding the rare earth elements) is observed from the surface to the center of the sintered magnet as one of features thereof. The sintered magnet can be manufactured by the examples of the method described below.

### Embodiment 5

A magnetic powder having an Nd₂Fe₁₄B structure as a main phase is prepared as an NdFeB type powder and a fluorine compound is formed on the surface of the magnetic powder. When DyF₃ is formed to the surface of the magnetic powder, Dy(CH₃COO)₃ as a starting material is dissolved with H₂O, and HF is added. By the addition of HF, gelatin-like DyF₃.XH₂O or DyF₃.X(CH₃COO) (X represents an positive integer) is formed. It is centrifugally separated, and the solvent is removed to form a light permeable solution.

The magnetic powder is placed in a mold to form a temporary molding material in a magnetic field at 10 kOe under a load of 1 t/cm². Continuous voids are present in the temporary molding material. Only the bottom of the temporary molding material is impregnated in the light permeable solution. The bottom is a plane parallel with the magnetic field direction. The solution is impregnated into the voids between the magnetic powders of the temporary molding material from the bottom and the lateral side in which light permeable solution is coated on the surface of the magnetic powder. Then, the solvent of the light permeable solution is evaporated and water of hydration is evaporated by heating and then the product is sintered at about 1100° C.

During sintering, Dy, C, and F constituting the fluorine compound are diffused along the surface or the grain boundary of the magnetic powder to cause such inter-diffusion as replacing Nd and Fe that constitute the magnetic powder. Particularly, in the vicinity of the grain boundary, diffusion causing replacement between Dy and Nd proceeds to form a structure where Dy is segregated along the grain boundary. An oxyfluoride compound or a fluorine compound is formed at the grain boundary triple junction to reveal that the compound comprises DyF₃, DyF₂, DyOF, etc.

A sintered magnet sized 10×10×10 mm is prepared by the steps described above and, as a result of analysis for the cross section thereof by wavelength dispersion X-ray spectroscopy, the ratio between the average fluorine concentration to 100 μm depth including the surface and the average fluorine concentration in the vicinity of the center of the magnets at a depth of 4 mm or more is 1.0±0.5 as a result of measurement for the area of 100×100 μm while changing the measurement point for 10 places.

In the sintered magnet described above, the coercive force is increased by 40%, the residual magnetic flux density is decreased by 2% by the increase of the coercive force, and Hk is increased by 10%, compared with the case not using the fluorine compound. By impregnating DyF₂, DyF₃, or Dy(O,F) fluorine compound from one surface of the temporary molding material by using the DyF type solution and completing the impregnation treatment before the impregnation solution reaches the opposite surface, a portion where only a portion of the magnet is impregnated with the fluoride solution can be formed and the impregnated portion after sintering provides a high coercive force portion.

Such a high coercive force portion can be formed at an optional position from the surface of the sintered magnet and only the portion of a high demagnetization field can be provided with large coercive force in the motor.

### Embodiment 6

A magnetic powder of about 7 μm average grain size comprising an Nd₂Fe₁₄B structure as a main phase and having about 1% boride or rare earth rich phase is prepared as the NdFeB type powder and a fluorine compound is formed on the surface of the magnetic powder. When DyF₃ is formed on the surface of the magnetic powder, Dy(CH₃COO)₃ is dissolved as the starting material with H₂O and HF is added. By the addition of HF, gelatin-like DyF₃.XH₂O or DyF₃.X(CH₃COO) (X represents a positive integer) is formed.

This is centrifugally separated, and the solvent is removed to form a light permeable solution. The magnetic powder is placed in a mold and a temporary molding material is prepared in a magnetic field of 10 kOe under a load of 1 t/cm². The density of the temporary molding material is about 60% and continuous voids are present from the bottom to the upper surface of the temporary molding material.

Only a portion of the bottom of the temporary molding material is immersed in the light permeable solution. The solution starts to impregnate into the voids of the magnetic powder of the temporary molding material and the light permeable solution is impregnated to the surface of the magnetic powder at the magnetic powder voids by evacuation. Then, the solvent of the impregnated light permeable solution is evaporated along the continuous voids, water of hydration is evaporated by heating and the product is sintered in a vacuum heat treatment furnace while keeping at a temperature of about 1100° C. for 3 hours.

During sintering, Dy, C, and F that constitute the fluorine compound are diffused along the surface or the grain boundary of the magnetic powder to cause such inter-diffusion that Nd and Fe that constitute the magnetic powder are replaced with Dy, C, F. Particularly, in the vicinity of the grain boundary, a diffusion where Dy replaces Nd proceeds to form a structure where Dy is segregated along the vicinity of the grain boundary.

Grains of an oxyfluoride compound or a fluorine compound is formed at grain boundary triple points or the grain boundary and it is confirmed that the grain comprises DyF₃, DyF₂, DyOF, NdOF, NdF₂, NdF₃, etc. and Dy or fluorine is at a high concentration from the inside of the grain to the grain boundary for some grains by TEM-EDX (electron microscope energy dispersion X-ray) by using an electron beam of 1 nm diameter.

Fluorine atoms are detected at the central portion of the grain boundary and Dy is concentrated in a range from 1 nm to 500 nm on the average from the central portion of the grain boundary. In the vicinity of the Dy concentrated portion, a region where the Dy concentration decreases from the center of the crystal grain to the direction of the grain boundary is observed and as a result of diffusion of the Dy atoms added previously into the grain to the vicinity of the grain boundary, a concentration gradient is present in which the Dy concentration is once decreased from the center of the grain to the grain boundary and, further, increased in the vicinity of the grain boundary.

The Dy concentration as the ratio to Nd (Dy/Nd) for the distance from the center of the grain boundary to 100 nm is from ½ to 1/10. In such a sintered magnet, the coercive force is increased by 40%, the residual magnetic flux density is decreased by 2% by the increase of the coercive force, and Hk is increased by 10% compared with the case of not using the fluorine compound.

The sintered magnet in which the fluorine compound is impregnated to a portion of the magnet is disposed on the outer periphery of the rotor of the motor. The position of impregnation, that is, the high coercive force portion may be present only at the end on the outer circumference of the sintered magnet or may be bilaterally asymmetrical in the peripheral direction from the pole center, along the cross section perpendicular to the axial direction of the rotor.

By providing such an impregnation position only to the specified portion of the magnet, the amount of heavy rare earth elements used for the entire process can be decreased. In the case of a cubic magnet, the specified portion of the magnet can be changed, for example, only in the vicinity of four corners, at four corners and in the vicinity of the side, at two corners and in the vicinity of the side, a portion of 6 planes including four corners, etc. depending on the region of the magnetic field concentration portion by the motor design.

Further, by improving the reliability of the magnet the reliability of the motor is also improved by increasing the coating area at the end parallel with the axial direction not keeping the area constant for the cross section of the magnet perpendicular to the axial direction of the motor.

The composition in the vicinity of the grain boundary changes in the vicinity of the boundary between the impregnated region and the not impregnated region. The fluorine concentration at the center of the grain boundary or the triple point of the grain boundary can be analyzed as a twice or higher level in the impregnated region when compared with the not impregnated region as a result of analysis by using the energy dispersion type X-ray analyzer.

Further, the average width of the grain boundary in the impregnated region is larger by 1.1 to 20 times than the width of the grain boundary for the not impregnated region, and the Dy concentration is higher in the inside of the grain along the grain boundary than that in the central portion of the grain boundary. Further, in the impregnated region, the Dy concentration is higher at the outer periphery of the crystal grains of the Nd₂Fe₁₄B parent phase in the inside of the grain than at the position for the grain boundary triple point.

### Embodiment 7

The DyF type treating solution is prepared by dissolving Dy acetate in water and adding a diluted hydrofluoric acid gradually. A solution formed by mixing an oxyfluoride compound or oxyfluoride carbide to gelled precipitates of the fluorine compound is stirred by using a supersonic stirrer, and methanol is added after centrifugal separation and a gelled methanol solution is stirred and then anions are removed to make the solution transparent. From the treating solution, anions are removed till the transmittance at a visible light is 5% or higher. The solution is impregnated into a temporary molding material. The temporary molding material is prepared by applying a load of 5 t/cm² to an Nd₂Fe₁₄B magnetic powder in a magnetic field of 10 kOe and has 20 mm thickness and 60% density on the average.

Since the density of the temporary molding material does not reach 100% density as described above, continuous voids are present in the temporary molding material. The solution is impregnated by about 0.1 wt % into the voids. The molding material is brought into contact with the solution with the surface perpendicular to the direction of applying the magnetic field as a bottom, and the solution is impregnated into the voids between the magnetic powders.

In this case, the solution is impregnated along the voids by evacuation and the solution is coated till the surface opposite to the bottom. The solvent of the coating solution is evaporated by an applying vacuum heat treatment to the impregnated temporary molding material at 200° C. The impregnated temporary molding material is placed in a vacuum heat treatment furnace and sintered by heating under vacuum up to a sintering temperature of 1000° C. to obtain an anisotropic sintered magnet at 99% density. Compared with the sintered magnet with no impregnation treatment, the sintered magnet applied with the impregnation treatment by the DyF type treating solution has a feature that Dy is segregated in the vicinity of the grain boundary also at the central portion of the magnet and much F, Nd, and oxygen are contained at the grain boundary, Dy in the vicinity of the grain boundary increases the coercive force and shows properties of the coercive force at 25 kOe and the residual magnetic flux density at 1.5 T at 20° C.

Since the concentration of Dy and F is high in the coated portion as an impregnation path, concentration difference is recognized and the fluoride is formed continuously in the direction of the face immersed in the impregnation solution and the surface opposite thereto. On the other hand, since a discontinuous portion is also observed in the direction perpendicular thereto, the concentration is high on the average at the surface of impregnation solution and the surface opposite thereto, while the concentration is low on the average in the perpendicular direction. This can be distinguished by SEM-EDX, TEM-EDX or EELS, EPMA.

Further, also when the surface of the sintered magnet is polished, since the fluorine containing phase is formed along the penetration voids by the impregnation treatment, a continuous fluorine containing phase is formed from the surface to another surface and no significant difference is formed for the fluorine concentration between the central portion of the magnet and the surface of the magnet.

As a result of analyzing the average concentration of the fluorine at the surface of a 100 μm square, the ratio between the surface and the central portion of the magnet is 1±0.5. The ratio for the average concentration for Dy, C, Nd other than fluorine is also 1±0.5.

Impregnation treatment with the DyFC type solution and sintering provide one of the following effects of improvement for the squareness of magnetic properties, increase of the resistance after molding, decrease of the temperature dependence of the coercive force, decrease of the temperature dependence of residual magnetic flux density, improvement of the corrosion resistance, increase of the mechanical strength, improvement of the heat conductivity and improvement in the bondability of the magnet.

As the fluorine compound, the DyF₃ of the DyF type, as well as LiF, MgF₂, CaF₂, ScF₃, VF₂, VF₃, CrF₂, CrF₃, MnF₂, MnF₃, FeF₂, FeF₃, CoF₂, CoF₃, NiF₂, ZnF₂, AlF₃, GaF₃, SrF₂, YF₃, ZrF₃, NbF₅, AgF, InF₃, SnF₂, SnF₄, BaF₂, LaF₂, LaF₃, CeF₂, CeF₃, PrF₂, PrF₃, NdF₂, SmF₂, SmF₃, EuF₂, EuF₃, GdF₃, TbF₃, TbF₄, DyF₂, NdF₃, HoF₂, HoF₃, ErF₂, ErF₃, TmF₂, TmF₃, YbF₃, YbF₂, LuF₂, LuF₃, PbF₂, BiF₃, or the fluorine compounds described above containing compounds containing oxygen, carbon, or transition metal element are also applicable to the impregnation step and can be formed by impregnation treatment using a solution transparent to visible rays or a solution in which CH group and a portion of fluorine are bonded, thereby capable of forming a fluorine containing layer which is continuous from the surface to the central portion of the magnet or from a magnet surface to the magnet surface on the opposite side. Further plate-like fluorine compound or oxyfluoride compound is recognized at the grain boundary or in the grain.

### Embodiment 8

The DyF type treating solution is prepared by dissolving Dy acetate in water, and adding a diluted hydrofluoric acid gradually. A solution formed by mixing an oxyfluoride compound or oxyfluoride carbide to gelled precipitates of the fluorine compound is stirred by using a supersonic stirrer and methanol is added after centrifugal separation, a gelled methanol solution is stirred, and then anions are removed to make the solution transparent. From the treating solution, anions are removed till the transmittance at a visible light is 10% or higher. The solution is impregnated into a temporary molding material. The temporary molding material is prepared by applying a load of 5 t/cm² to an Nd₂Fe₁₄B magnetic powder at an aspect ratio of 2 on the average in a magnetic field of 10 kOe and has 20 mm thickness and 70% density on the average.

Since the density of the temporary molding material does not reach 100% density as described above continuous voids are present in the temporary molding material. The solution is impregnated into the voids. The molding material is brought into contact with the solution with the surface perpendicular to the direction of applying the magnetic field as a bottom, and the solution is impregnated into the voids between the magnetic powders.

In this case, the solution is impregnated along the voids by evacuation and the solution is coated till the surface opposite to the bottom. The solvent of the coating solution is evaporated by an applying vacuum heat treatment to the impregnated temporary molding material at 200° C. The impregnated temporary molding material is placed in a vacuum heat treatment furnace and sintered by heating under vacuum up to a sintering temperature of 1000° C. to obtain an anisotropic sintered magnet at 99% density. A phase containing Dy and F is formed as a layer continuous from the surface to the opposite surface of the magnet, and the thickness is from 0.5 to 5 nm excepting for a specific point such as a grain boundary triple point.

Compared with the sintered magnet with no impregnation treatment, the sintered magnet applied with the impregnation treatment by the DyF type treating solution has a feature that F, Nd and oxygen are present at high content to the grain boundary in which Dy is segregated within 500 nm from the vicinity of the grain boundary center, Dy in the vicinity of the grain boundary increases the coercive force and the magnet shows properties of the coercive force of 30 kOe and the residual magnetic flux density of 1.5 T at 20° C.

When a sintered magnet sized 10×10×10 mm is prepared by the steps described above and, as a result of analysis for the cross section thereof by wavelength dispersion X-ray spectroscopy, the ratio between the average fluorine concentration to 100 μm depth including the surface and the average fluorine concentration in the vicinity of the center of the magnet at a depth of 4 mm or more is 1.0±0.3 as a result of measurement for the area of 100×100 μm while changing the measurement point for 10 places.

In the sintered magnet described above, compared with the case not using the fluorine compound, the coercive force is increased by 40% and the residual magnetic flux density is decreased by 0.1% by the increase of the coercive force and Hk is increased by 10%.

Since the sintered magnet impregnated with the fluorine compound has a high energy product, it is applicable to a rotary machine for hybrid cars. In addition to the improvement of the property as described above, impregnation treatment with the DyF type solution and sintering provide one of the effects of improvement for the squareness of magnetic properties, increase of the resistance after molding, decrease of the temperature dependence of coercive force, decrease of the temperature dependence of residual magnetic flux density, improvement of the corrosion resistance, increase of the mechanical strength, improvement of the heat conductivity, and improvement in the bondability of the magnet.

As the fluorine compound, the DyF₃ of the DyF type, as well as LiF, MgF₂, CaF₂, ScF₃, VF₂, VF₃, CrF₂, CrF₃, MnF₂, MnF₃, FeF₂, FeF₃, CoF₂, CoF₃, NiF₂, ZnF₂, AlF₃, GaF₃, SrF₂, YF₃, ZrF₃, NbF₅, AgF, InF₃, SnF₂, SnF₄, BaF₂, LaF₂, LaF₃, CeF₂, CeF₃, PrF₂, PrF₃, NdF₂, SmF₂, SmF₃, EuF₂, EuF₃, GdF₃, TbF₃, TbF₄, DyF₂, NdF₃, HoF₂, HoF₃, ErF₂, ErF₃, TmF₂, TmF₃, YbF₃, YbF₂, LuF₂, LuF₃, PbF₂, BiF₃, or the fluorine compounds described above containing compounds containing oxygen, carbon, or transition metal element are also applicable to the impregnation step and can be formed by impregnation treatment using a solution transparent to visible rays or a solution in which a CH group and a portion of fluorine are bonded, and a plate-like fluorine compound or oxyfluoride compound is recognized at the grain boundary or in the grain.

While the invention has been described in its preferred embodiments, it is to be understood that the words which have been used are words of description rather than limitation and that changes within the purview of the appended claims may be made without departing from the true scope and spirit of the invention in its broader aspects.

What is claimed is:

1. A sintered magnet motor having a sintered magnet rotor, the rotor comprising:
a ferromagnetic material comprising iron as a main ingredient to be sintered;
a fluorine compound or an oxyfluoride compound formed in the inside of a crystal grain or to a portion of a grain boundary of the ferromagnetic material; and
at least one of-alkalis, alkaline earth elements, and rare earth elements contained in the fluorine compound or the oxyfluoride compound;
a portion of the fluorine compound or the oxyfluoride compound being distributed with a concentration gradient established from the surface to the inside of the ferromagnetic material, and a rare earth element being distributed with a concentration gradient established between the grain boundary surface and the parent phase of the ferromagnetic material,
wherein the concentration distribution of the fluorine compound is asymmetrical when viewed from the pole center of the sintered magnet rotor.

2. A sintered magnet motor having a sintered magnet rotor, the rotor comprising:
a sintered magnet material comprising iron as a main ingredient;
a fluorine compound or an oxyfluoride compound formed in the inside of a crystal grain or to a portion of the grain boundary of the material for the sintered magnet; and
at least one of alkalis, alkaline earth elements, and rare earth elements contained in the fluorine compound or the oxyfluoride compound;
a portion of the fluorine compound or the oxyfluoride compound extending so as to pass through the surface of the ferromagnetic material to the inside and to be continuous for the other surface of the ferromagnetic material, and
the rare earth element being distributed with a concentration gradient established between the grain boundary surface and the parent phase of the ferromagnetic material,
wherein the concentration distribution of the fluorine compound is asymmetrical when viewed from the pole center of the sintered magnet rotor.

3. A sintered magnet motor having a sintered magnet rotor, the rotor comprising:
a sintered magnet material comprising iron as a main ingredient;
a fluorine compound or an oxyfluoride compound formed in the inside of a crystal grain or to a portion of the grain boundary of the material for the sintered magnet; and
at least one of alkalis, alkaline earth elements, and rare earth elements contained in the fluorine compound or the oxyfluoride compound;
a portion of the fluorine compound or the oxyfluoride compound extending so as to pass through the surface of the ferromagnetic material to the inside and to be continuous for the other surface of the ferromagnetic material, and
fluorine being distributed with a concentration gradient established between the grain boundary surface and the parent phase of the ferromagnetic material,
wherein the concentration distribution of the fluorine is asymmetrical when viewed from the pole center of the sintered magnet rotor.

4. A sintered magnet motor having a sintered magnet rotor, the rotor comprising:
a sintered magnet material comprising iron as a main ingredient;
a fluorine compound or an oxyfluoride compound formed in the inside of a crystal grain or to a portion of the grain boundary of the material for the sintered magnet; and
at least one of alkalis, alkaline earth elements, and rare earth elements contained in the fluorine compound or the oxyfluoride compound;
a portion of the fluorine compound or the oxyfluoride compound extending so as to extend from the surface of the ferromagnetic material along the crystal grain boundary and to be continuous for the other surface of the ferromagnetic material, and,
fluorine being distributed with a concentration gradient established between the grain boundary surface and the parent phase of the ferromagnetic material,
wherein the concentration distribution on the average of the fluorine is asymmetrical when viewed from the pole center of the sintered magnet rotor.

5. A sintered magnet motor having a sintered magnet rotor, the rotor comprising:
a sintered magnet material comprising iron as a main ingredient;
a fluorine compound or an oxyfluoride compound formed in the inside of a crystal grain or to a portion of the grain boundary of the material for the sintered magnet; and
at least one of alkalis, alkaline earth elements, and rare earth elements contained in the fluorine compound or the oxyfluoride compound;
a portion of the fluorine compound or the oxyfluoride compound extending so as to pass through the surface of the ferromagnetic material to the inside and to be continuous for the other surface of the ferromagnetic material, and
fluorine being distributed with a concentration gradient established between the grain boundary surface and the parent phase of the ferromagnetic material,
wherein symmetricity for the distribution of the residual magnetic flux density of a sintered magnet is different from that for the distribution of the coercive force thereof, the sintered magnet being disposed along the outer periphery of the sintered magnet rotor.

6. A sintered magnet motor comprising:
a ferromagnetic material comprising iron and a rare earth element as a main ingredient;
a fluorine compound or an oxyfluoride compound formed in the inside of a crystal grain or to a portion of the grain boundary of the ferromagnetic material;
at least one of alkalis, alkaline earth elements, metal elements, and rare earth elements, and carbon, which are contained in the fluorine compound or the oxyfluoride compound; and
a continuous layer which extends such that the fluorine compound or the oxyfluoride compound may not be connected to the outermost surface at the grain boundary at any portion of the ferromagnetic material;
wherein at least one of the alkalis, alkaline earth elements, metal elements, or rare earth elements segregates along the grain boundary of the parent phase of the ferromagnetic material along the continuous layer; at least one of the alkalis, alkaline earth elements, metal elements, and rare earth elements segregates so as to increase the concentration from the center to the outside of the grain in the grain having a cubic structure of the fluorine compound or the oxyfluoride compound; and the concentration distribution of the rare earth element obtained by the analysis of the composition for the volume of 100 μm³ or more is laterally asymmetrical about the pole of the sintered magnet rotor.

7. A sintered magnet motor having a rotor including a sintered magnet, the sintered magnet comprising:
a ferromagnetic material comprising iron as a main ingredient to be sintered; and
a fluorinated portion formed in the ferromagnetic material, the fluorinated portion obtained by subjecting a fluoride compound or an oxyfluoride compound to a fluorination treatment;
wherein the fluorinated portion is narrowed in the central portion in the axial direction of the rotor and widened on both ends apart from the central portion in the axial direction.

8. A sintered magnet motor having a rotor including a sintered magnet, the sintered magnet comprising:
a ferromagnetic material comprising iron as a main ingredient to be sintered; and
a fluorinated portion formed in the ferromagnetic material, the fluorinated portion obtained by subjecting a fluoride compound or an oxyfluoride compound to a fluorination treatment;
wherein a not-fluorinated portion except for the fluorinated portion is present at the central portion of two planes perpendicular to an anisotropic direction.
